(19) United States
(12) Patent Application Publication
(10) Pub. No.: US 2016/0173556 A1
(43) Pub. Date: Jun. 16, 2016

(54) METHOD AND APPARATUS FOR TRANSMITTING/RECEIVING MEDIA BROADCASTING SIGNAL IN REAL TIME TRANSPORT PROTOCOL-BASED BROADCASTING SYSTEM

(71) Applicant: LG ELECTRONICS INC., Seoul (KR)

(72) Inventors: Jungwook PARK, Seoul (KR); Kyoungsoo MOON, Seoul (KR); Woosuk KWON, Seoul (KR); Sejin OH, Seoul (KR)

(73) Assignee: LG ELECTRONICS INC., Seoul (KR)

(21) Appl. No.: 14/902,781

(22) PCT Filed: Jul. 4, 2014
(86) PCT No.: PCT/KR2014/006011

§ 371 Date: Jan. 4, 2016

Related U.S. Application Data
(60) Provisional application No. 61/843,053, filed on Jul. 5, 2013.

(51) Int. Cl. H04L 29/06; H04N 21/44; H04L 29/08; H04N 21/6437; H04N 21/854; H04N 21/8547; H04N 21/434; H04N 21/236

(52) U.S. Cl. CPC H04L 65/608; H04N 21/4348; H04N 21/44004; H04N 21/23614; H04N 21/6437; H04N 21/85406; H04N 21/8547; H04L 67/06; H04L 69/22

(57) ABSTRACT

The present invention relates to a method for transmitting a media broadcasting signal and an apparatus for receiving the media broadcasting signal in a broadcasting system. The apparatus for receiving the media broadcasting signal comprises: a receiving unit for receiving a packet by a protocol for real time transport, wherein the payload of the packet includes a media file format (MFF) divided according to the type of data, and the divided media file format (MFF) file is one of an initial past MFF file comprising meta data having entire play information and initial play information, and a media part MFF file including meta data having media data and partial play information related to the media data; a parsing unit for distinguishing the meta data and the media data from each other by analyzing the media file format (MFF) file and extracting information required to play; a decoder for decoding the media file format (MFF) file output from the parsing unit; and a play unit for playing a decoded media file format (MFF) file by using the information extracted from the parsing unit.

### FIELD OF THE INVENTION

The present invention relates to a method and/or apparatus for transmitting/receiving a media broadcasting signal in a broadcasting system. And, more specifically, the present invention relates to a method and/or apparatus for transmitting/receiving a media broadcasting signal in a real time transport protocol-based broadcasting system.

### BACKGROUND ART

With the evolution in the communication technology, media broadcasting have now become available for transmission and reception in real time, and playing (or playback) of media broadcasting is not available in real time. In order to perform real time transmission (or transport) of media broadcasting, a real time transport protocol is used, and the real time transport protocol corresponds to a protocol that is used for transmitting (or transporting) media, such as audio, video, and so on.

The media packet according to the real time transport protocol is configured to have a simple structure in order to allow processing of the packet to be carried out swiftly by a receiving end, and the media packet is also designed to be adequate for real time play. Furthermore, the media packet is also designed to be available for multicasting.

However, in case of Real time Transport Protocol, such as in HTTP (Hyper Text Transfer Protocol), interaction (or communication) between the transmitter and the receiver, such as a re-request of a damaged packet, is impossible to be carried out. Therefore, difficulty in transmitting a Media File Format (MFF) file that is adequate for a storage medium specific media format exists.

The Media File Format (MFF) is configured of data units referred to as boxes. The corresponding boxes are referred to as ftyp, moov, mdat, and the MFF is configured in a hierarchical format, wherein metadata and media data are divided. The metadata generally include information, such as a Brand name of a file and distinction, decoding and playback (or play) time (or time point) respective to the actual media information. And, the media data include actual media data that are to be processed by the decoder. In case of the Media File Format (MFF) file, the receiving end may play the corresponding media only after receiving the metadata as well as the media data.

Accordingly, the real time transport protocol has a characteristic of having to be played at the same time as the reception of the data, and the Media File Format (MFF) file has a characteristic of being available for play only after the reception of all data associated with the play is completed. Therefore, in order to transmit a Media File Format (MFF) file in real time, in case of using the real time transport protocol, difficulty caused by the different characteristics, which are described above, exist.

Furthermore, in case the MFF file is being transmitted through the real time transport protocol, since there is no method for allowing the receiver to recognize whether or not the file that is being transmitted in the packet level corresponds to a MFF file, problems exist in performing real time reception and play of the corresponding file.

### DETAILED DESCRIPTION OF THE INVENTION

### Technical Objects

In order to resolve the above-described problems, an object that is to be achieved by the present invention is to provide a method and/or apparatus for transmitting/receiving a media broadcasting signal in a real time transport protocol-based broadcasting system.

Furthermore, an object that is to be achieved by the present invention is to provide signaling information that is adequate for the transmission of a real time transport protocol-based media file format.

Furthermore, an object that is to be achieved by the present invention is to provide a method of identifying that the data being transmitted via real time transport protocol correspond to a Media File Format (MFF).

### Technical Solutions

According to an exemplary embodiment of the present invention, an apparatus for receiving a media broadcasting signal includes a receiving unit for receiving a packet by a protocol for real time transport, wherein a payload of the packet includes a Media File Format (MFF) divided according to types of data, and the divided Media File Format (MFF) file corresponds to any one of an initial partial MFF file comprising metadata having entire play information and initial play information, and a media partial MFF file including metadata having media data and partial play information associated with the media data, wherein a header of the packet includes Media File Format (MFF) type information identifying whether the divided Media File Format (MFF) file included in the payload corresponds to an initial partial MFF file or a media partial MFF file, a parsing unit for distinguishing the metadata and the media data from each other by analyzing the Media File Format (MFF) file and extracting information required for the play, a decoder for decoding the Media File Format (MFF) file outputted from the parsing unit, and a play unit for playing a decoded Media File Format (MFF) file by using the information extracted from the parsing unit.

Preferably, the apparatus for receiving a media broadcasting signal further includes a buffer for storing data included in a payload of the received packet, and a control unit for performing control operations so as to store the initial partial MFF file in the buffer, in case of receiving a packet including an initial partial MFF file, and for performing control operations so as to verify whether or not the initial partial MFF file is stored in the buffer, in case of receiving a packet including a media partial MFF file, and, if the file is stored in the buffer, to output the media partial MFF file to the parsing unit along with the initial partial MFF file stored in the buffer, and, if the file is not stored in the buffer, to allow the receiving unit to receive a new packet.

Preferably, a header of the packet may include Payload Type information indicating a format of the data included in the payload, and the Payload Type information may identify whether or not the data included in the payload correspond to a Media File Format (MFF).

Preferably, a header of the packet may further include Timestamp information indicating a start point at which the Media File Format (MFF) file included in the payload is played, and the packet including the initial partial MFF file may have Timestamp information the same as or faster than that of the packet including the media partial MFF file.

Preferably, the packet including the initial partial MFF file may be continuously received on a periodic basis.

Preferably, the protocol for real time transport may include a RTP (Real time Transport Protocol).

Preferably, the Media File Format (MFF) may include an ISOBMFF (ISO Base Media File Format).

According to another exemplary embodiment of the present invention, a method for transmitting a media broadcasting signal includes a step of encoding media data including audio data and/or video data to a Media File Format (MFF), a step of dividing the encoded Media File Format (MFF) file into an initial partial MFF file comprising metadata having entire play information and initial play information, and a media partial MFF file including metadata having media data and partial play information associated with the media data in accordance with the type of data, a step of creating a packet including the divided Media File Format (MFF) file in accordance with a protocol for real time transport, wherein a header of the created packet includes Media File Format (MFF) type information identifying whether the divided Media File Format (MFF) file included in the payload corresponds to an initial partial MFF file or a media partial MFF file, and a step of transmitting the created packet.

Preferably, a header of the created packet may include Payload Type information indicating a format of the data included in the payload, and the Payload Type information may identify whether or not the data included in the payload correspond to a Media File Format (MFF).

Preferably, a header of the created packet may further include Timestamp information indicating a start point at which the Media File Format (MFF) file included in the payload is played, and the packet including the initial partial MFF file may have Timestamp information the same as or faster than that of the packet including the media partial MFF file.

Preferably, the packet including the initial partial MFF file may be continuously received on a periodic basis.

Preferably, the protocol for real time transport may include a RTP (Real time Transport Protocol).

Preferably, the Media File Format (MFF) may include an ISOBMFF (ISO Base Media File Format).

### Effects of the Invention

According to the present invention, a real time transport protocol-based broadcasting system may transmit (or transport) a Media File Format (MFF) in real time.

According to the present invention, a real time transport protocol-based broadcasting system may receive and play a Media File Format (MFF) in real time.

### BRIEF DESCRIPTION OF THE DRAWINGS

FIG. 1 illustrates a header structure of a RTP (Real time Transport Protocol) packet according to an exemplary embodiment of the present invention.

FIG. 2 illustrates a structure of a Media File Format (MFF) according to an exemplary embodiment of the present invention.

FIG. 3 illustrates an apparatus for receiving a media broadcasting signal playing a Media File Format (MFF) file in a stream format by using the real time transport protocol according to an exemplary embodiment of the present invention.

FIG. 4 illustrates a Syntax of a fixed header of a Real time transport protocol packet according to an exemplary embodiment of the present invention.

FIG. 5 illustrates Payload Type information (Payload Type) being used in the real time transport protocol according to an exemplary embodiment of the present invention.

FIG. 6 illustrates a Syntax having Media File Format (MFF) Type information (MFF Type) included in an extension header of the real time transport protocol packet according to an exemplary embodiment of the present invention.

FIG. 7 illustrates values and significance of the Media File Format (MFF) Type information (MFF Type) according to an exemplary embodiment of the present invention.

FIG. 8 illustrates a structure of a Completed MFF according to an exemplary embodiment of the present invention.

FIG. 9 illustrates a structure of an Initial Partial MFF according to an exemplary embodiment of the present invention.

FIG. 10 illustrates a structure of a Media Partial MFF according to an exemplary embodiment of the present invention.

FIG. 11 illustrates a data processing procedure in a receiving apparatus, in a case when the MFF file is divided in accordance with data types and transmitted, according to an exemplary embodiment of the present invention.

FIG. 12 illustrates a Syntax having Fragment Indicator information (Fragment Indicator) included in an extension header of the real time transport protocol packet according to an exemplary embodiment of the present invention.

FIG. 13 illustrates values and significance of the Fragment Indicator information (Fragment Indicator) according to an exemplary embodiment of the present invention.

FIG. 14 illustrates a data processing procedure in a receiving apparatus in a case when the MFF file is divided in accordance with data types and data sizes and transmitted according to an exemplary embodiment of the present invention.

FIG. 15 illustrates a header of a RTP packet including a Completed MFF according to an exemplary embodiment of the present invention.

FIG. 16 illustrates a header of a RTP packet in a case when the MFF file is divided into an Initial Partial MFF file and a Media Partial MFF file and then transmitted through the RTP packet according to an exemplary embodiment of the present invention.

FIG. 17 illustrates structures of a RTP packet and a Completed MFF in a case when the Completed MFF is included in a payload of the RTP packet and then transmitted according to an exemplary embodiment of the present invention.

FIG. 18 illustrates structures of a RTP packet and an Initial Partial MFF in a case when the Initial Partial MFF is included in a payload of the RTP packet and then transmitted according to an exemplary embodiment of the present invention.

FIG. 19 illustrates structures of a RTP packet and a Media Partial MFF in a case when the Media Partial MFF is included in a payload of the RTP packet and then transmitted according to an exemplary embodiment of the present invention.

FIG. 20 illustrates a header of a RTP packet in a case when the MFF file is divided in accordance with data types and data sizes and transmitted through the RTP packet according to an exemplary embodiment of the present invention.

FIG. 21 illustrates an operation flow of an apparatus for receiving a hybrid broadcasting service, which is based on an association between a groundwave (or terrestrial) broadcasting network and an internet protocol network, according to an exemplary embodiment of the present invention.

FIG. 22 illustrates a flow of a method for transmitting a media broadcasting signal according to an exemplary embodiment of the present invention.

### BEST MODE FOR CARRYING OUT THE INVENTION

Hereinafter, although the exemplary embodiments of the present invention will be described in detail with reference to the accompanying drawings and the details indicated in the accompanying drawings, the present invention will not be limited only to the exemplary embodiments of the present invention.

Additionally, for the terms used in this specification, general terms that are currently most broadly used have been selected based upon the functions according to the technical scope and spirit of the present invention. However, such terms may be varied in accordance with the intentions of anyone skilled in the art, general practice, or an advent of a new technology. Additionally, in some particular cases, some of the terms used herein have been arbitrarily selected by the applicant, and, in this case, the significance of such terms will be described in detail in the corresponding part of the detailed description of the invention. Accordingly, the corresponding terms used in this specification should not be understood by the term itself, and should be interpreted based upon the actual significance of the term and the overall context of this specification.

For convenience in the understanding and description of the present invention, terms and abbreviations will be defined as described below.

Among the terms used in the detailed description of the present invention, a Media File Format (MFF) signifies a data format of a media file, such as an audio file or a video file, and, for example, MP4 (MPEG-4), 3GP (3GPP file format), ASF (Advanced Streaming Format), WMV (Windows Media Video), ISOBMFF (ISO Base Media File Format), and so on, may correspond to the Media File Format. Additionally, the Media File Format may be abbreviated as MFF.

ISOBMFF (ISO Base Media File Format) defines a general structure for time-based multimedia files, such as audio or video, and may also be used as a basic structure of other Medial File Formats, such as MP4 or 3GP.

Payload Type may be referred to as Payload Type information.

MFF Type may be referred to as Media File Format (MFF) information.

Fragment Indicator may be referred to as Fragment Indicator information.

Timestamp may be referred to as Timestamp information.

Initial Partial MFF may be referred to as an Initial Part MFF or an Initial Partial MFF file (Initial Partial MFF).

Media Partial MFF may be referred to as a Media Part MFF or a Media Partial MFF file (Media Partial MFF).

As protocols for real time video or audio streaming, RTP (Real time Transport Protocol), RTCP (RTP Control Protocol), RTSP (Real Time Streaming Protocol), RTMP (Real Time Messaging Protocol), and so on, may correspond to the real time transport protocol according to the exemplary embodiment of the present invention, which is to be used in this specification. Hereinafter, although the present invention will be described by using RTP, among the real time transport protocols, as its exemplary embodiment, the spirit of the present invention will not be limited only to this.

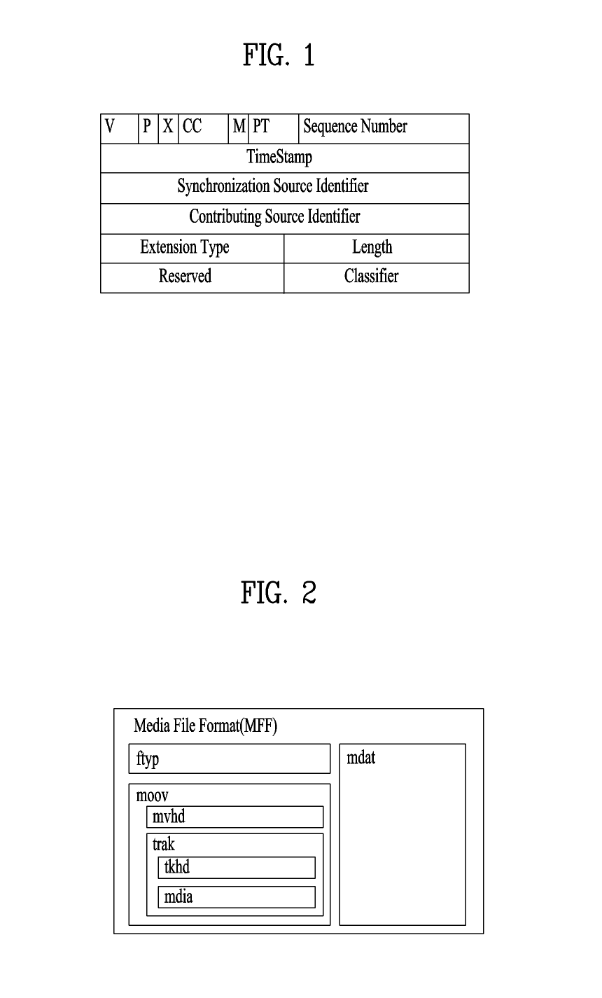

FIG. 1 illustrates a header structure of a RTP (Real time Transport Protocol) packet according to an exemplary embodiment of the present invention.

The RTP (Real time Transport Protocol) corresponds to a protocol for transporting (or transmitting) media, such as audio and video.

As shown in the drawing, a header of the RTP is comparatively simplified, which allows a receiving end to quickly process the packet. Information required for media play, such as Sequence Number, TimeStamp, and so on, is defined in the header of the RTP in order to realize a design adequate for real time play. Additionally, by using the header of the RTP packet of this drawing, multicasting may be performed, thereby allowing information to be simultaneously received from one transmitter to multiple receivers. Additionally, by being provided with an Extension header (Extension Type), the header of the RTP packet may be prepared for extendability respective to future service development.

However, in case of Real time Transport Protocol, such as in HTTP (Hyper Text Transfer Protocol), interaction (or communication) between the transmitter and the receiver, such as a re-request of a damaged packet, may be impossible to be carried out.

The header of a RTP packet according to an exemplary embodiment of the present invention includes V (Version), P (Padding), X (Extension), CC (CSRC Count), M (Marker), PT (Payload Type), Sequence Number, TimeStamp, SSRC Identifier (Synchronization Source Identifier), CSRC Identifier (Contributing Source Identifier), Extension Type, Length, Reserved, and/or Classifier.

V (Version) indicates a version of the protocol.

P (Padding) indicates whether or not a padding byte exists. When this field is set, padding bytes are included at the end of the RTP packet. These padding bytes are used in an encryption algorithm or used for matching the packet length.

X (Extension) indicates whether or not an extension header exists between a fixed header and a payload.

CC (CSRC Count) indicates how many CSRC identifiers are included after the fixed header.

M (Marker) is used for indicating (or marking) frame boundaries, and so on, of media.

PT (Payload Type) indicates a format of the payload. This may indicate encoding types of audio or video.

Sequence Number indicates a sequence number of the packet. This is incremented by 1 for each RTP packet that is being transmitted. The receiving end may detect packet damage and may recover the packet sequence by using this field. An initial value of the Sequence Number shall be randomly set.

TimeStamp indicates a first sampling time (or time point) of a RTP data packet. The receiver may allow a synchronous play of the received media to be carried out by using this field.

SSRC Identifier (Synchronization Source Identifier) identifies a source of a RTP stream.

CSRC Identifier (Contributing Source Identifier) identifies sources configuring the media included in a packet.

FIG. 2 illustrates a structure of a Media File Format (MFF) according to an exemplary embodiment of the present invention.

As shown in the drawing, the MFF is configured of data units referred to as boxes. The corresponding boxes are referred to as ftyp, moov, mdat, and the MFF is configured in a hierarchical format, wherein metadata and media data are divided. The metadata generally include information, such as a Brand name of a file and distinction, decoding and playback (or play) time (or time point) respective to the actual media information. And, the media data may include actual media data that are to be processed by the decoder. Herein, the receiver may play the corresponding media only after receiving the metadata but as well as the media data

As shown in the drawing, the MFF may include ftyp (file type box), moov (movie box) and/or mdat (media data box).

ftyp (file type box) corresponds to a box indicating the file type and compatibility of the file and may be referred to as a file type box.

moov (movie box) corresponds to a box storing all metadata associated with the media data and may also be referred to as a movie box. The moov (movie box) may include mvhd (movie header box) and/or trak (track box), and the trak (track box) may include tkhd (trak header box) and/or mdia (media box). The mvhd (movie header box) corresponds to a box indicating the movie header. The trak (track box) corresponds to a box indicating each track or stream. The tkhd (track header box) corresponds to a box including overall information associated with the track and may be referred to as a track header box. The mdia (media box) corresponds to a box indicating information on the media data within the track.

mdat (media data box) corresponds to a box storing actual media data and may be referred to as a media data box.

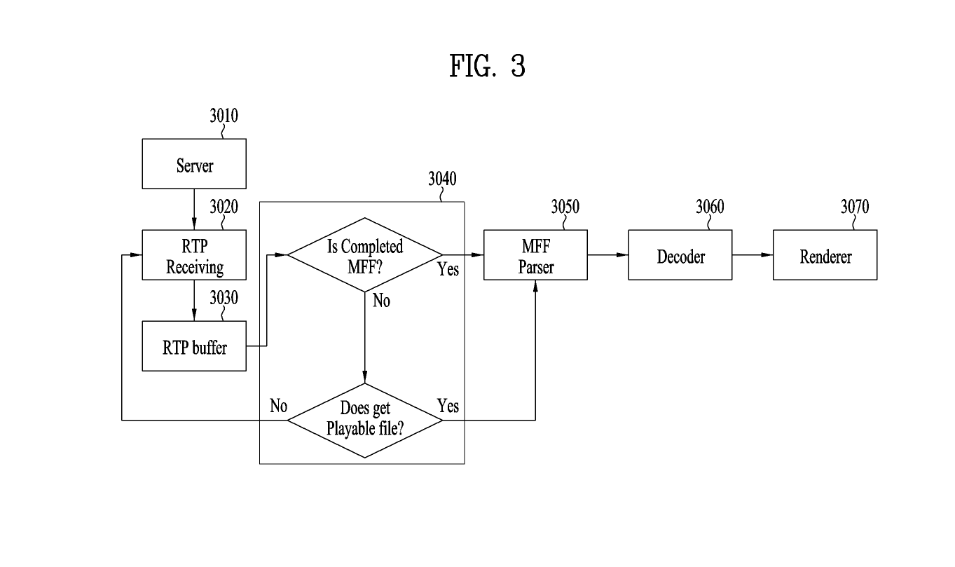

FIG. 3 illustrates an apparatus for receiving a media broadcasting signal playing a Media File Format (MFF) file in a stream format by using the real time transport protocol according to an exemplary embodiment of the present invention.

The apparatus for receiving a media broadcasting signal according to the exemplary embodiment of the present invention may include a Server (3010), a receiving unit (RTP Receiving; 3020), a buffer (RTP buffer; 3030), a control unit (3040), a parsing unit (MFF Parser; 3050), a Decoder (3060), and/or a play unit (Renderer; 3070).

The Server (3010) indicates a stored position of the MFF file that is to be received.

The receiving unit (RTP Receiving; 3020) may receive a packet in accordance with the Real time Transport Protocol from the server (3010).

The RTP buffer (or buffer) (3030) may analyze the packet, which is received by the RTP Receiving (or receiving unit), so as to analyze a sequence of the received packet, a playing time point of the data, and required buffer size, and may then store the payload data in the buffer.

The control unit (3040) analyzes payload type information included in the header of the received packet, and, in case the payload type is MFF, the control unit (3040) may perform control operations so that the payload data stored in the RTP buffer (3030) can be outputted to the MFF Parser (3050). In case the MFF file is divided and transmitted in accordance with the data type or data size, the control unit (3040) verifies a Media File Format type information (MFF Type) value of the packet of the data stored in the RTP buffer (3030), and when the value is equal to “00”, the control unit (3040) determines the MFF as a Completed MFF and may, then, perform control operations so that the MFF can be outputted to the MFF Parser (3050). The control unit (3040) verifies a Media File Format type information (MFF Type) value of the stored packet, and when the value is not equal to “00”, the control unit (3040) may determine whether or not playback (or play) can be performed. The control unit (3040) verifies a fragment indicator information (fragment indicator) value of the packet, and, in case packets corresponding to “01” and “11” are received, since all of the divided data starting from the beginning and the end have been received, the control unit (3040) performs control operations so that the packet can be outputted to the MFF Parser (3050), and the control unit (3040) may perform control operations so that the packet can be continuously received until the packet having a fragment indicator information (fragment indicator) value equal to “11” is received. The control unit (3040) verifies a Media File Format type information (MFF Type) value of the stored packet, and when the value is equal to “01”, the control unit (3040) may perform control operations so that an Initial Partial MFF file (Initial Partial MFF), which is included in the packet and then received, can be stored in the buffer. The control unit verifies a Media File Format type information (MFF Type) value of the stored packet, and when the value is equal to “10”, i.e., when the value indicates that the file being included in the packet and received corresponds to a Media Partial MFF file (Media Partial MFF), the control unit first verifies whether or not an Initial Partial MFF file (Initial Partial MFF) is stored in the buffer, and, if it is stored in the buffer, the control unit performs control operations so that the Media Partial MFF file is outputted to the MFF Parser (3050) along with the Initial Partial MFF file, which is stored in the buffer, and, if the Initial Partial MFF file us bit stored in the buffer, the control unit may perform control operations so that the RTP Receiving (or receiving unit) (3020) can receive a new packet. The Completed MFF, the Initial Partial MFF file (Initial Partial MFF), the Media Partial MFF file (Media Partial MFF), which are mentioned above, will hereinafter be described in detail.

The parsing unit (MFF Parser; 3050) may analyze the MFF file and distinguish the metadata from the media data and may then extract other information required for play (or playback).

The Decoder (3060) receives the corresponding media information from the MFF Parser (3050) at each decoding time point.

The play unit (Renderer; 3070) may perform a function of playing the data, which are decoded by the decoder (3060), at each play time point extracted by the MFF Parser (3050).

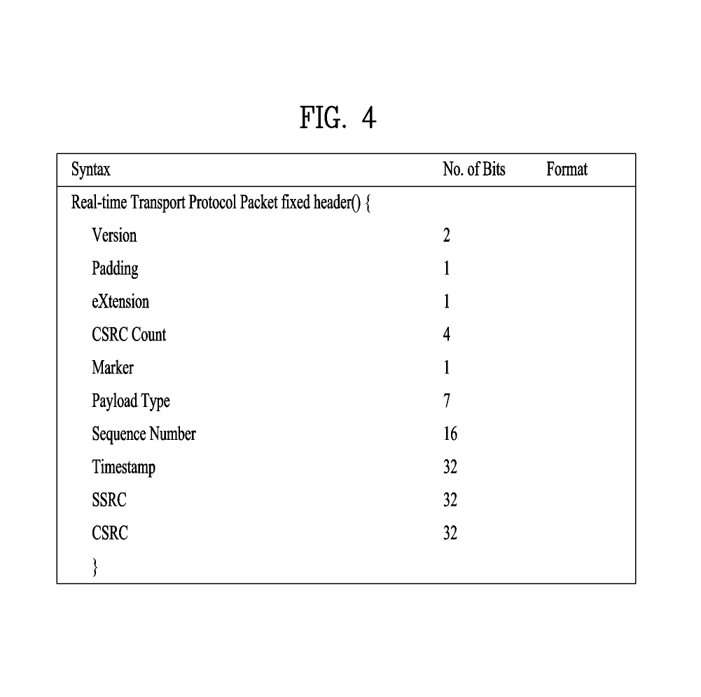

FIG. 4 illustrates a Syntax of a fixed header of a Real time transport protocol packet according to an exemplary embodiment of the present invention.

A fixed header of the Real time Transport Packet according to the exemplary embodiment of the present invention may include a Version field, a Padding field, an eXtension field, a CSRC Count field, a Marker field, a Payload Type field, a Sequence Number field, a Timestamp field, a SSRC field, and/or a CSRC field.

The Version field indicates a version of the RTP, and this field is fixed to 2.

The Padding field indicates whether or not a padding byte exists. When this field is set, padding bytes are included at the end of the RTP packet. These padding bytes are used in an encryption algorithm or used for matching the packet length.

The eXtension field indicates whether or not an extension header exists between a fixed header and a payload. In the exemplary embodiment of the present invention, this field will be marked as 1 for additional information that is required for the transmission of an ISO Base Media File Format file.

The CSRC Count field indicates how many CSRC identifiers are included after the fixed header.

The Marker field is interpreted differently depending upon the profile, and this field is used for marking important events, such as frame boundaries.

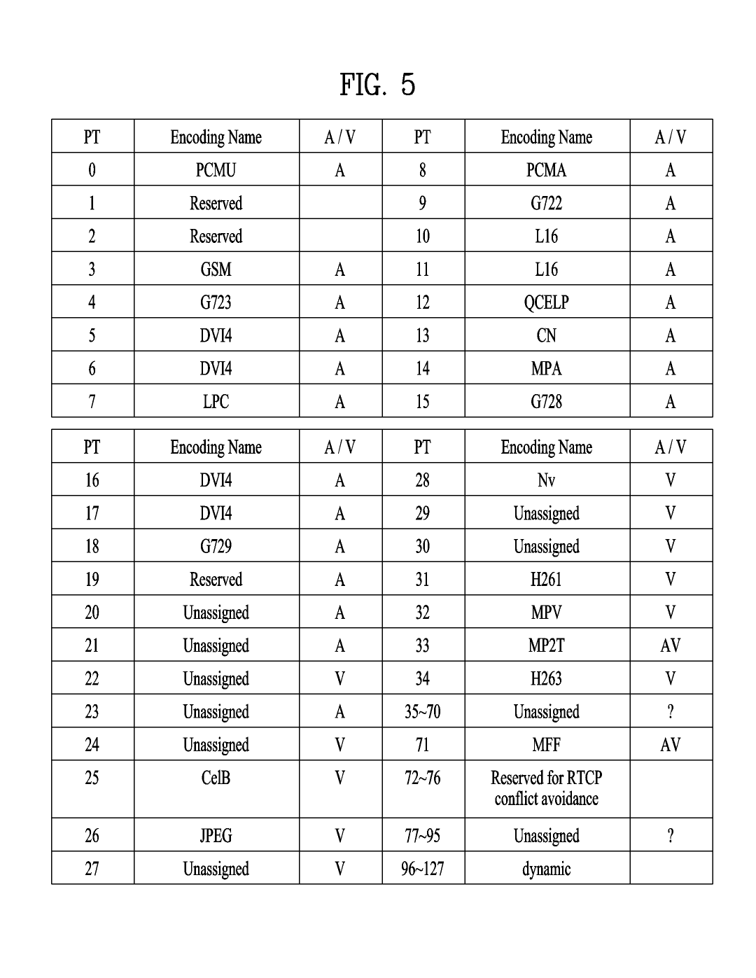

The Payload Type field indicates the format of data that are to be transmitted by the packet. The data type is determined by a packet end through the corresponding information and preparations may be made for the decoding. The Payload Type being used in the RTP is defined in RFC 3551 and is described as shown in FIG. 5. In the present invention, as the exemplary embodiment, although the Payload Type value “71” is temporarily defined as a packet type for the transmission of a MFF file, this may also be defined as values of “3571” or “77127”.

The Sequence Number field corresponds to information indicating a sequence of the packet that is being transmitted, and its start point begins from a random number. Additionally, this field is incremented by 1 for each time a packet is being transmitted.

The Timestamp field indicates a time point at which the corresponding packet has been sampled. A timing when the payload data of this packet is to be played may be known. The value of the time unit information may vary depending upon the data described in the payload. In this exemplary embodiment of the present invention, this field indicates a start point at which the MFF file is being played.

The SSRC field is used for distinguishing each media stream source that is being received. Multiple media may be streamed synchronously in one session, and a value of this field is used in order to distinguish them from one another. In one session, different SSEC values shall be respectively assigned for each the media sources. Moreover, the SSRC field is used as a data separator for synchronization, and this value may be arbitrarily generated.

The CSRC field is used as a descriptor for a transmission contributor. This value is arbitrarily generated and may be given up to a maximum of 15 values.

The Payload field includes data bytes encoded to MFF. In the exemplary embodiment of the present invention, the MFF being included in the Payload has a prerequisite of including a Mandatory Box, and, whenever required, as an Optional Box is additionally included, the Payload field may be provided with extendability for the MFF.

FIG. 5 illustrates Payload Type information (Payload Type) being used in the real time transport protocol according to an exemplary embodiment of the present invention.

PT indicates a value of the payload type, and Encoding Name indicates an encoding type of the data included in the payload. Additionally, A/V indicates whether the corresponding data correspond to audio or video.

In the exemplary embodiment of the present invention, the Payload Type information (Payload Type) value “71” is temporarily defined as a packet type for the transmission of a MFF file, this may also be defined as values of “3571” or “77127”.

Since a value for the MFF is not defined in the value of the Payload Type in a legacy RTP protocol, the conventional (or legacy) receiver was incapable of recognizing the corresponding format when transmitting a MFF in the RTP packet level. However, according to the exemplary embodiment of the present invention, by adding a Payload Type value of the RTP packet for the MFF, the receiver is capable of distinguishing data in the RTP packet level. Accordingly, the receiver may increase efficiency in data processing.

More specifically, according to the exemplary embodiment of the present invention, a method for identifying the data included in the payload as MFF within the Real time Transport Protocol may be provided.

According to the exemplary embodiment of the present invention, the Payload Type information may identify data included in the payload as a Media File Format (MFF).

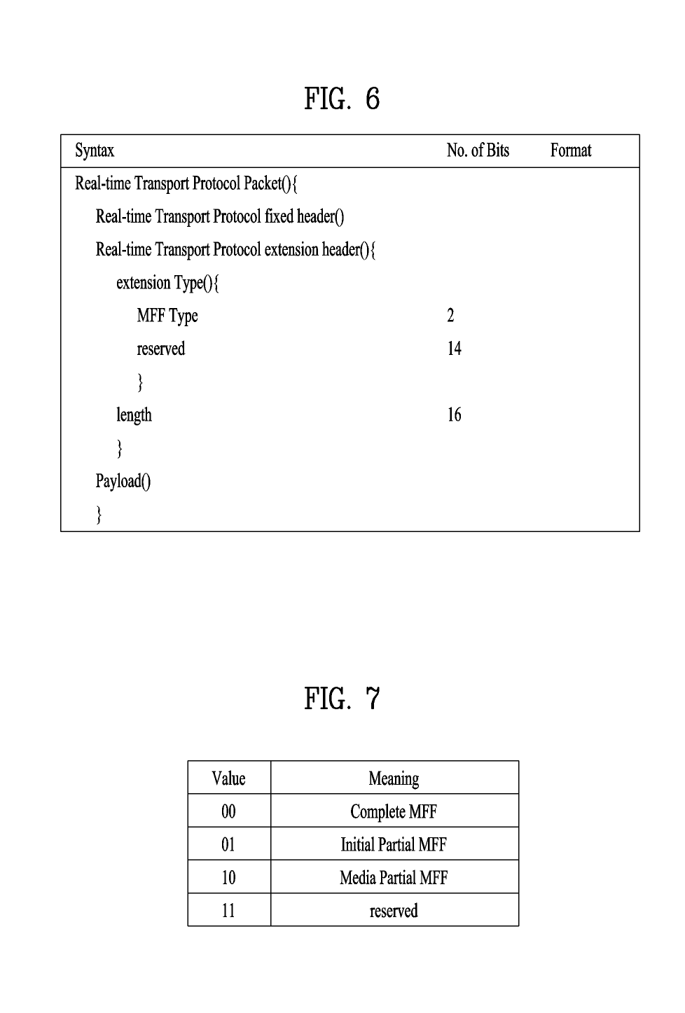

FIG. 6 illustrates a Syntax having Media File Format (MFF) Type information (MFF Type) included in an extension header of the real time transport protocol packet according to an exemplary embodiment of the present invention.

According to the exemplary embodiment of the present invention, the Real time Transport Protocol packet may be extended, and, then, the MFF file may be divided in accordance with the data type and may then be transmitted.

According to the exemplary embodiment of the present invention, the Real time Transport Protocol packet may include a RTP fixed header (Real time Transport Protocol fixed header), a RTP extension header (Real time Transport Protocol extension header), and a payload. A Timestamp field may be included in the RTP fixed header, and Media File Format Type information (MFF Type) may be included in the RTP extension header.

The Timestamp field indicates a time point at which the corresponding packet has been sampled. A timing (or timing point) when the payload data of this packet is to be played may be known. The value of the time unit information may vary depending upon the data described in the payload. In this exemplary embodiment of the present invention, this field indicates a start point at which the MFF file is being played. Additionally, in case the MFF file is divided and then transmitted, the packets including the divided data may all be given the same Timestamp value.

The MFF Type field corresponds to information for distinguishing the MFF file that is being transmitted. By using the corresponding field, the receiver may be capable of performing analysis on whether or not play can be carried out independently by using only the corresponding packet, or whether or not play can be carried out by additionally receiving another type of data packet. The significance (or meaning) of the value of the corresponding field will be described later on.

According to the exemplary embodiment of the present invention, in case the MFF file is divided and transmitted in accordance with the data type, the receiver may distinguish the packet by using the MFF Type field, which is included in the extension header of the RTP packet.

The MFF may be divided into any one of a Completed MFF, which is available for an independent play by using a single format, an Initial Partial MFF, which includes only metadata having entire play information and initial play information based upon an efficiency in the transmission rate, and a Media Partial MFF, which includes metadata and media data, wherein the metadata has partial play information that is associated with the media data, and may then be transmitted.

For example, when a 20-seconds-long content is divided into an Initial Partial MFF, a Media Partial MFF (5 seconds), a Media Partial MFF (5 seconds), and a Media Partial MFF (10 seconds), and then transmitted, an entire play time respective to the 20 seconds, information that can distinguish tracks, and other common metadata may be included in the Initial Partial MFF and may then be transmitted periodically by the transmitter. Additionally, the metadata, such as information on a sample (video frame) boundary of each corresponding time point and decoding time information, and the actual media data may be included in the Media Partial MFF and may, then, be sequentially transmitted. At this point, since the Initial Partial MFF should be received firsthand in order to allow the media play to be carried out by the receiver, the Initial Partial MFF should be periodically transmitted by the transmitting end in order to allow the media play for the Media Partial MFF to be initiated.

FIG. 7 illustrates values and significance of the Media File Format (MFF) Type information (MFF Type) according to an exemplary embodiment of the present invention.

If the value of the MFF Type is equal to “00”, this indicates that the divided MFF corresponds to a Complete MFF. The Complete MFF may signify a file that includes the entire metadata and media data and that can be independently played on its own.

If the value of the MFF Type is equal to “01”, this indicates that the divided MFF corresponds to an Initial Partial MFF file (Initial Partial MFF). The Initial Partial MFF file (Initial Partial MFF) may signify a file that includes metadata having entire play information and initial play information associated with a media file.

If the value of the MFF Type is equal to “10”, this indicates that the divided MFF corresponds to a Media Partial MFF file (Media Partial MFF). The Media Partial MFF file (Media Partial MFF) may signify a file that includes media data and metadata having partial play information associated with the media data

A value “11” of the MFF Type signifies a reserved value.

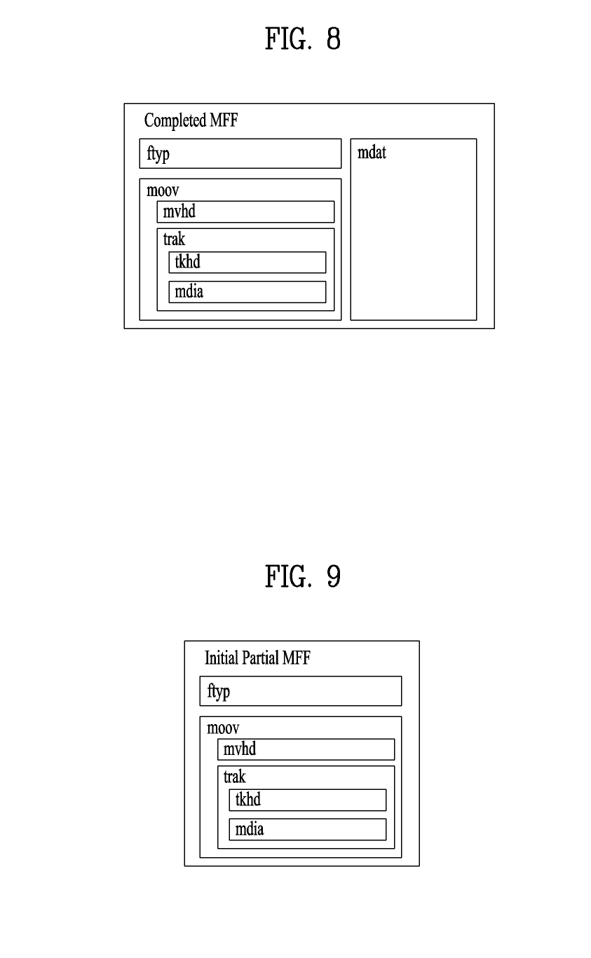

FIG. 8 illustrates a structure of a Completed MFF according to an exemplary embodiment of the present invention.

According to the exemplary embodiment of the present invention, the Complete MFF is inserted in the RTP Payload and then transmitted, and, since the Complete MFF all of the metadata and media data that are required for the play, media play can be performed independently.

As shown in this drawing, the Complete MFF has the same structure as a Media File Format (MFF) that is not divided. Therefore, the description provided above on the drawing showing the structure of the Media File Format (MFF) will be substituted for the detailed description related to this drawing.

FIG. 9 illustrates a structure of an Initial Partial MFF according to an exemplary embodiment of the present invention.

The Initial Partial MFF according to the exemplary embodiment of the present invention is configured of a shared Mandatory box showing the entire play information of the media and metadata carrying information associated with an overall initial media play. Herein, the information included in the Initial Partial MFF may be analyzed by the MFF Parser (3050) of the apparatus for receiving a media broadcasting signal according to the exemplary embodiment of the present invention. Additionally, the Initial Partial MFF file should be periodically transmitted to the receiver, and, by doing so, the receiver may prepare itself for the media play.

The description provided above on the drawing showing the structure of the Media File Format (MFF) will be substituted for the description on each box configuring the Initial Partial MFF according to the exemplary embodiment of the present invention.

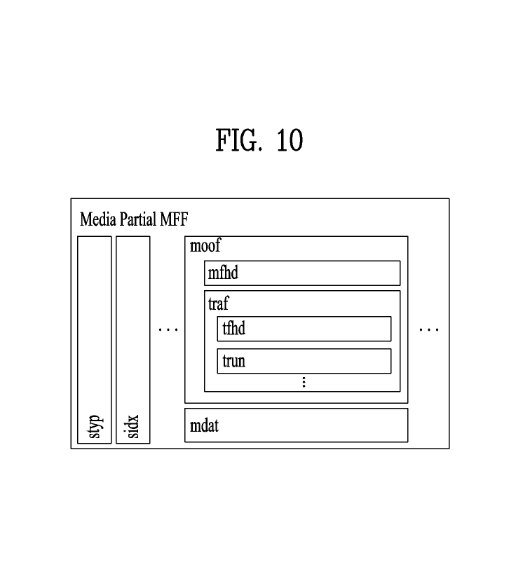

FIG. 10 illustrates a structure of a Media Partial MFF according to an exemplary embodiment of the present invention.

The Media Partial MFF according to the exemplary embodiment of the present invention may include divided media data and metadata having partial play information associated with the media data The media data that are included in the Media Partial MFF and then transmitted may be played after being transmitted and received.

The media data that are being transmitted by the RTP according to the exemplary embodiment of the present invention, media play is possible only after receiving all of the Initial Partial MFF and the Media Partial MFF. In case only any one of the Initial Partial MFF and the Media Partial MFF is received, media play is not possible.

The Media Partial MFF according to the exemplary embodiment of the present invention may include styp (segment type box), sidx (segment index box), moof (movie fragment box) and/or mdat (media data box).

styp (segment type box) corresponds to a box indicating the file type of the media segment and compatibility of the file and may be referred to as a file type box.

sidx (segment index box) corresponds to a box indexing each media segment. Diverse information, such as track information, divided sequence number, total length of the divided media, and so on, may be included in the sidx box.

moof (movie fragment box) corresponds to a box indicating which media samples are included in the mdat box, which will be described later on. The moof (movie fragment box) may include mfhd and/or traf, and the traf (track fragment box) may include tfhd (movie fragment header box) and/or trun (track fragment run box). The mfhd (movie fragment header box) corresponds to a box indicating the movie fragment header. The traf (track fragment box) corresponds to a box including the metadata associated with each track fragment. The tkhd corresponds to a box indicating the track fragment header. The trun (track fragment run box) indicates track fragment runs, and the traf may include 0 or more truns. The receiver may know information on boundaries and playing time point of samples in the mdat box, number of samples, and so on, through the trun box.

mdat (media data box) corresponds to a box storing actual media data

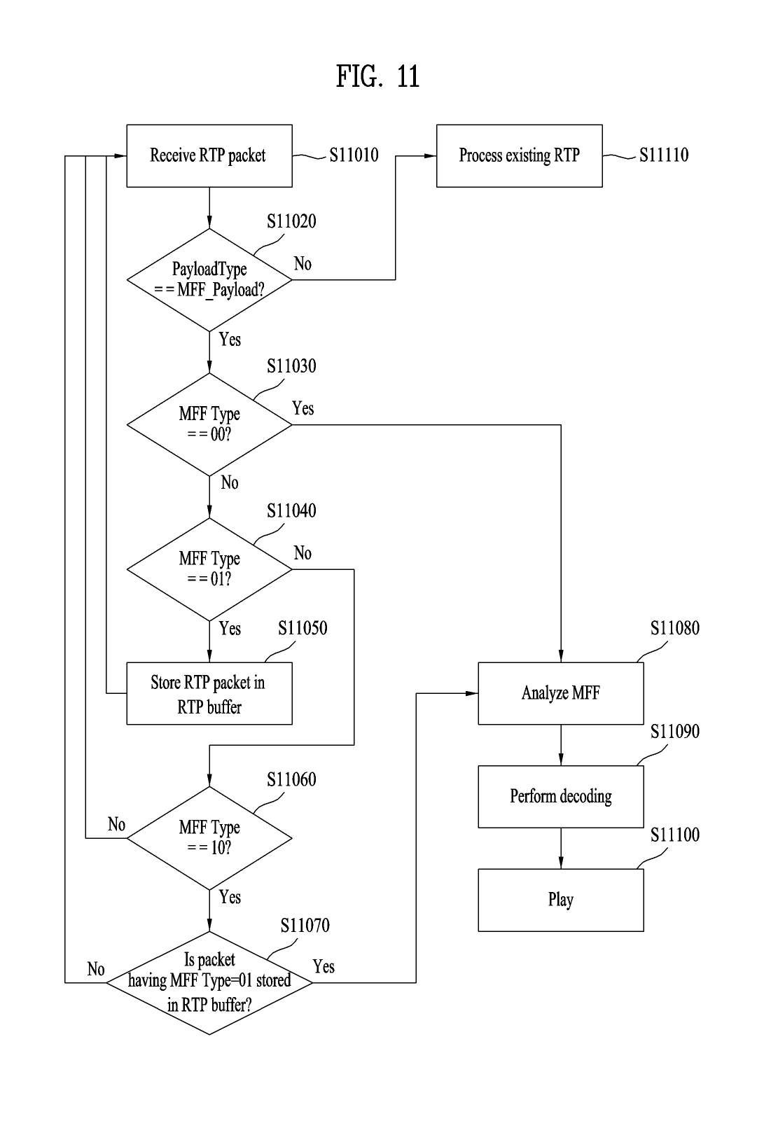

FIG. 11 illustrates a data processing procedure in a receiving apparatus, in a case when the MFF file is divided in accordance with data types and transmitted, according to an exemplary embodiment of the present invention.

In case the MFF file is divided in accordance with data types and transmitted according to the exemplary embodiment of the present invention, a processing procedure of data in the receiving apparatus may include a step of receiving an RTP packet (S11010), a step of verifying whether or not a Payload Type of the RTP packet is identical to a value indicating that the packet corresponds to a MFF (S11020), in case the Payload Type is not equal to the value indicating that the value corresponds to a MFF, a step of processing the data of the payload in accordance with a conventional RTP standard recommended method (S11110), in case the Payload Type is equal to the value indicating that the value corresponds to a MFF, a step of verifying whether or not the MFF Type is equal to “00” (S11030), a step of verifying whether or not the MFF Type is equal to “01” (S11040), in case the MFF Type is equal to “01”, a step of storing the corresponding packet in a RTP buffer (S11050), in case the MFF Type is not equal to “01”, a step of verifying whether or not the MFF Type is equal to “10” (S11060), in case the MFF Type is equal to “10”, a step of verifying whether or not the packet having the MFF Type of “10” is stored in the RTP buffer (S11070), in case the MFF Type is equal to “00”, or in case the MFF Type is equal to “10”, and in case a packet having a MFF type of “01” has been previously stored in the RTP buffer, a step of analyzing the MFF that is included in the corresponding packet (S11080), a step of decoding the MFF (S11090), and/or a step of playing the MFF (S11100).

The receiving apparatus receiving the RTP packet may carry out a general RTP analysis, thereby being capable of verifying the version, the presence or absence of an extension, the number of CSRCs, the packet sequence, the data play time point (or time point of data play), the SSRC, and/or the CSRC (S11010). At this point, in case the Payload Type of the RTP packet is equal to the value indicating that the packet corresponds to a MFF, a processing method of the MFF file according to the exemplary embodiment of the present invention is followed (S11020), and, in case the Payload Type is not equal to the value indicating that the packet corresponds to a MFF, the data of the payload may be processed in accordance with the conventional RTP standard recommended method (S11110).

In case the Payload Type is equal to the value indicating that the packet corresponds to a MFF, the MFF Type including in the extension header of the RTP packet according to the exemplary embodiment of the present invention may be verified (S11030).

In case the MFF Type is equal to “00” (S11030), since the corresponding Payload is a MFF that can be independently played, the corresponding Payload is directly delivered to the parsing unit (MFF Parser; 3050), thereby carrying out decoding and play (S11080, S11090, S11100).

However, in case the MFF Type is equal to “01” (S11040), the corresponding Payload may be recognized as an Initial Partial MFF, and, then, the corresponding packet is stored in the buffer until a packet having the MFF Type value of “01” is received, and a new RTP packet is received (S11050). At this point, in case the MFF Type of the RTP packet that is initially received is not equal to “00” and “01”, the receiver receives a new packet.

In case the MFF Type is equal to “10” (S11060), it is determined whether or not a RTP packet having the MFF Type value of “01” has already been received previously (S11070), and, in case a packet having the MFF Type value of “10” and a packet having the MFF Type value of “01” both exist, parsing, decoding, and playing are carried out on the packets stored in the buffer (S11080, S11090, S11100).

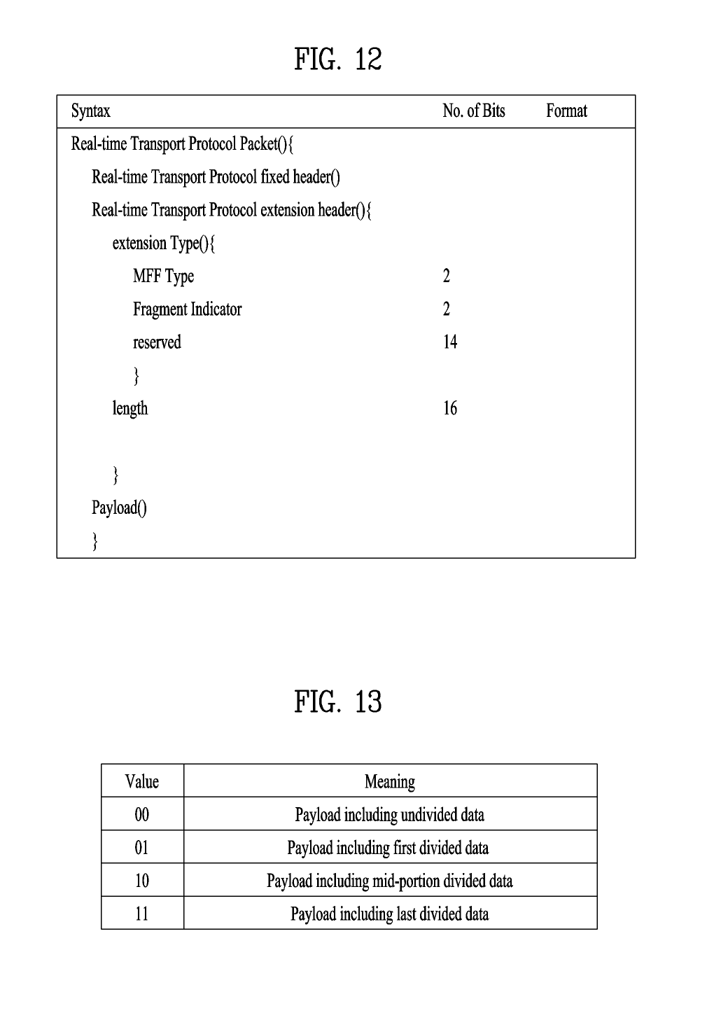

FIG. 12 illustrates a Syntax having Fragment Indicator information (Fragment Indicator) included in an extension header of the real time transport protocol packet according to an exemplary embodiment of the present invention.

According to the exemplary embodiment of the present invention, the Real time Transport Protocol packet may be extended, and, then, the MFF file may be divided in accordance with the data size and may then be transmitted.

According to the exemplary embodiment of the present invention, the Real time Transport Protocol packet may include a RTP fixed header (Real time Transport Protocol fixed header), a RTP extension header (Real time Transport Protocol extension header), and a payload. A Timestamp field may be included in the RTP fixed header, and Media File Format Type information (MFF Type) and Fragment Indicator information (Fragment Indicator) may be included in the RTP extension header.

The Timestamp field indicates a time point at which the corresponding packet has been sampled. A timing (or timing point) when the payload data of this packet is to be played may be known. The value of the time unit information may vary depending upon the data described in the payload. In this exemplary embodiment of the present invention, this field indicates a start point at which the MFF file is being played. Additionally, in case the MFF file is divided and then transmitted, the packets including the divided data may all be given the same Timestamp value.

The MFF Type field corresponds to information for distinguishing the MFF file that is being transmitted. By using the corresponding field, the receiver may be capable of performing analysis on whether or not play can be carried out independently by using only the corresponding packet, or whether or not play can be carried out by additionally receiving another type of data packet. The significance (or meaning) of the value of the corresponding field may be indicated as shown in FIG. 7.

According to the exemplary embodiment of the present invention, in case the MFF file is divided and transmitted in accordance with the data type, the receiver may distinguish the packet by using the MFF Type field, which is included in the extension header of the RTP packet.

In case the MFF is divided in accordance with the data size and then stacked in the RTP packet and then transmitted, the Fragment Indicator field may indicate information on the boundary of the data The significance (or meaning) of the value of the corresponding field will be described later on.

According to the exemplary embodiment of the present invention, in a situation where the packet size is limited (or restricted), in order to increase the transmission efficiency, the transmitting end may divide the MFF file in accordance with the data size and may then transmit the divided MFF file. The receiver may be capable of distinguishing the boundaries of the divided data through the Fragment Indicator field, which is included in the extension header of the RTP packet. More specifically, the data included in the received packet may be distinguished as any one of first divided data, mid-portion (or midsection) data, and last divided data of the MFF file through the Fragment Indicator field, and, accordingly, the boundary with another MFF file may be distinguished.

For example, in case the transmitter intends to consecutively transmit two large-sized MFF files to the receiver, the receiver may receive the RTP packet including the MFF file and verify the Sequence Number of the RTP and may, then, align the sequence (or order) of the packets. Thereafter, the receiver may verify the Payload Type, SSRC, CCRC and may, then, identify that the file being transmitted through the Payload Type value corresponds to a MFF file. At this point, the receiver may be capable of verifying that the first divided data and the last divided data have been received through the Fragment Indicator value of the extension header within the RTP packet, and, by using this, the receiver may verify the boundaries of the data and may know that one playable data has been fully received.

FIG. 13 illustrates values and significance of the Fragment Indicator information (Fragment Indicator) according to an exemplary embodiment of the present invention.

If the value of the Fragment Type is equal to “00”, this may indicate that the payload of the corresponding packet includes undivided data.

If the value of the Fragment Type is equal to “01”, this may indicate that the payload of the corresponding packet includes a first portion of the divided data.

If the value of the Fragment Type is equal to “10”, this may indicate that the payload of the corresponding packet includes a mid-portion (or midsection) of the divided data.

If the value of the Fragment Type is equal to “11”, this may indicate that the payload of the corresponding packet includes a last portion of the divided data.

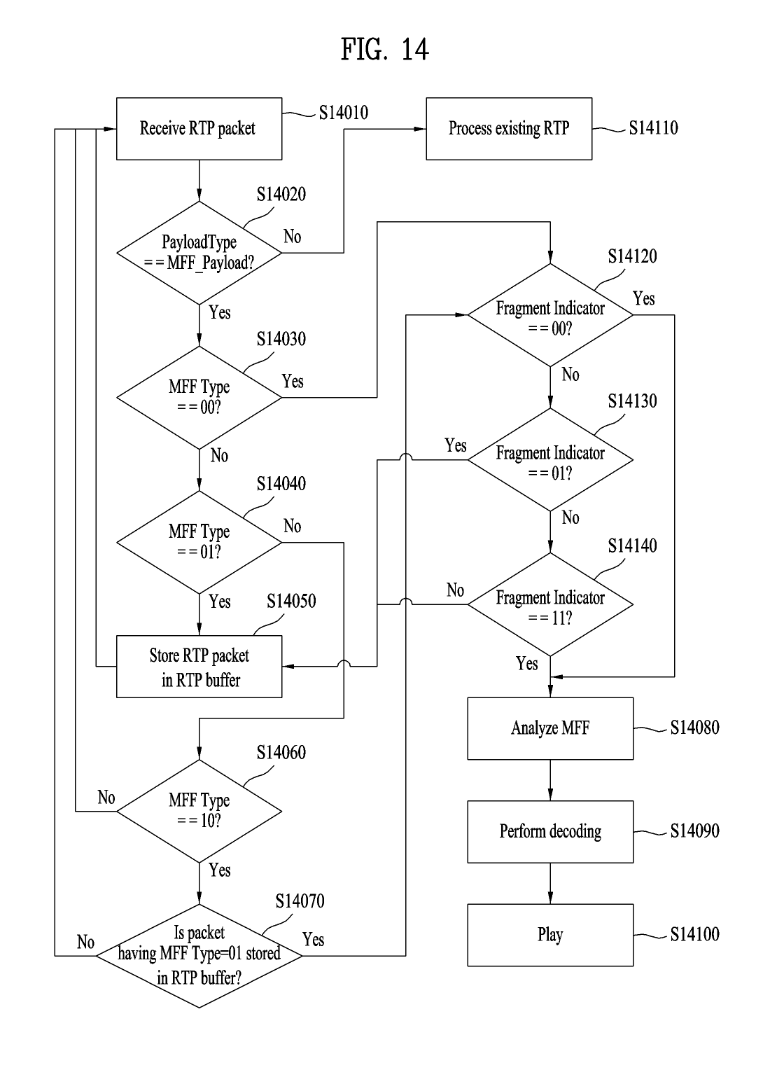

FIG. 14 illustrates a data processing procedure in a receiving apparatus in a case when the MFF file is divided in accordance with data types and data sizes and transmitted according to an exemplary embodiment of the present invention.

In case the MFF file is divided in accordance with data types and data sizes and transmitted according to the exemplary embodiment of the present invention, a processing procedure of data in the receiving apparatus may include a step of receiving an RTP packet (S14010), a step of verifying whether or not a Payload Type of the RTP packet is identical to a value indicating that the packet corresponds to a MFF (S14020), in case the Payload Type is not equal to the value indicating that the value corresponds to a MFF, a step of processing the data of the payload in accordance with a conventional RTP standard recommended method (S14110), in case the Payload Type is equal to the value indicating that the value corresponds to a MFF, a step of verifying whether or not the MFF Type is equal to “00” (S14030), a step of verifying whether or not the MFF Type is equal to “01” (S14040), in case the MFF Type is equal to “01”, a step of storing the corresponding packet in a RTP buffer (S14050), in case the MFF Type is not equal to “01”, a step of verifying whether or not the MFF Type is equal to “10” (S14060), in case the MFF Type is equal to “10”, a step of verifying whether or not the packet having the MFF Type of “10” is stored in the RTP buffer (S14070), in case the MFF Type is equal to “00”, or in case the MFF Type is equal to “10”, and in case a packet having a MFF type of “01” has been previously stored in the RTP buffer, a step of verifying whether or not the Fragment Indicator of the corresponding packet is equal to “00” (S14120), in case the Fragment Indicator of the corresponding packet is not equal to “00”, a step of verifying whether or not it is equal to “01” (S14130), in case the Fragment Indicator of the corresponding packet is not equal to “01”, a step of verifying whether or not it is equal to “11” (S14140), in case the Fragment Indicator of the corresponding packet is equal to “00” or “11”, a step of analyzing the MFF that is included in the corresponding packet (S14080), a step of decoding the MFF (S14090), and/or a step of playing the MFF (S14100).

The receiving apparatus receiving the RTP packet may carry out a general RTP analysis, thereby being capable of verifying the version, the presence or absence of an extension, the number of CSRCs, the packet sequence, the data play time point (or time point of data play), the SSRC, and/or the CSRC (S14010). At this point, in case the Payload Type of the RTP packet is equal to the value indicating that the packet corresponds to a MFF, a processing method of the MFF file according to the exemplary embodiment of the present invention is followed, and, in case the Payload Type is not equal to the value indicating that the packet corresponds to a MFF, the data of the payload may be processed in accordance with the conventional RTP standard recommended method (S14110).

In case the Payload Type is equal to the value indicating that the packet corresponds to a MFF, the MFF Type including in the extension header of the RTP packet according to the exemplary embodiment of the present invention may be verified (S14020).

In case the MFF Type is equal to “00”, since the corresponding Payload is a MFF that can be independently played, in this case, subsequently, a Fragment Indicator value included in the extension header of the RTP packet may be verified, thereby being capable of knowing whether or not the MFF file has been divided in accordance with the data size (S14030).

In case the value of the Fragment Type is equal to “00”, since this indicates that the data included in the payload of the corresponding packet corresponds to undivided data, the corresponding Payload is directly delivered to the MFF Parser so that decoding and play can be carried out (S14120).

In case the value of the Fragment Type is equal to “01”, since the corresponding packet includes a first portion of the divided data, the corresponding packet may be stored in the buffer, and new packets may be received until the last portion of the divided data is received (S14130).

In case the value of the Fragment Type is equal to “10”, since the corresponding packet includes a middle portion (or mid-portion) of the divided data, the corresponding packet may be stored in the buffer, and new packets may be received until the last portion of the divided data is received.

In case the value of the Fragment Type is equal to “11”, since the corresponding packet includes a last portion of the divided data, the corresponding packet is delivered to the MFF Parser along with the data of a previous sequence, which are stored in the buffer, so that decoding and play can be carried out (S14140, S14080, S14090, S14100).

However, in case the MFF Type is equal to “01”, the corresponding Payload may be recognized as an Initial Partial MFF (S14040), and, then, the corresponding packet is stored in the buffer until a packet having the MFF Type value of “01” is received, and a new RTP packet may be received (S14050). At this point, in case the MFF Type of the RTP packet that is initially received is not equal to “00” and “01”, the receiver receives a new packet.

In case the MFF Type is equal to “10”, it is determined whether or not a RTP packet having the MFF Type value of “01” has already been received previously (S14060, S14070), and, in case a packet having the MFF Type value of “10” and a packet having the MFF Type value of “01” both exist in the buffer, subsequently, a Fragment Indicator value included in the extension header of the RTP packet may be verified, thereby being capable of knowing whether or not the MFF file has been divided in accordance with the data size (S14120).

In case the value of the Fragment Type is equal to “00”, since this indicates that the data included in the payload of the corresponding packet corresponds to undivided data, the corresponding Payload is directly delivered to the MFF Parser so that decoding and play can be carried out (S14120, S14080, S14090, S14100).

In case the value of the Fragment Type is equal to “01”, since the corresponding packet includes a first portion of the divided data, the corresponding packet may be stored in the buffer, and new packets may be received until the last portion of the divided data is received (S14130, S14050).

In case the value of the Fragment Type is equal to “10”, since the corresponding packet includes a middle portion (or mid-portion) of the divided data, the corresponding packet may be stored in the buffer, and new packets may be received until the last portion of the divided data is received.

In case the value of the Fragment Type is equal to “11”, since the corresponding packet includes a last portion of the divided data, the corresponding packet is delivered to the MFF Parser along with the data of a previous sequence, which are stored in the buffer, so that decoding and play can be carried out (S14140, S14080, S14090, S14100).

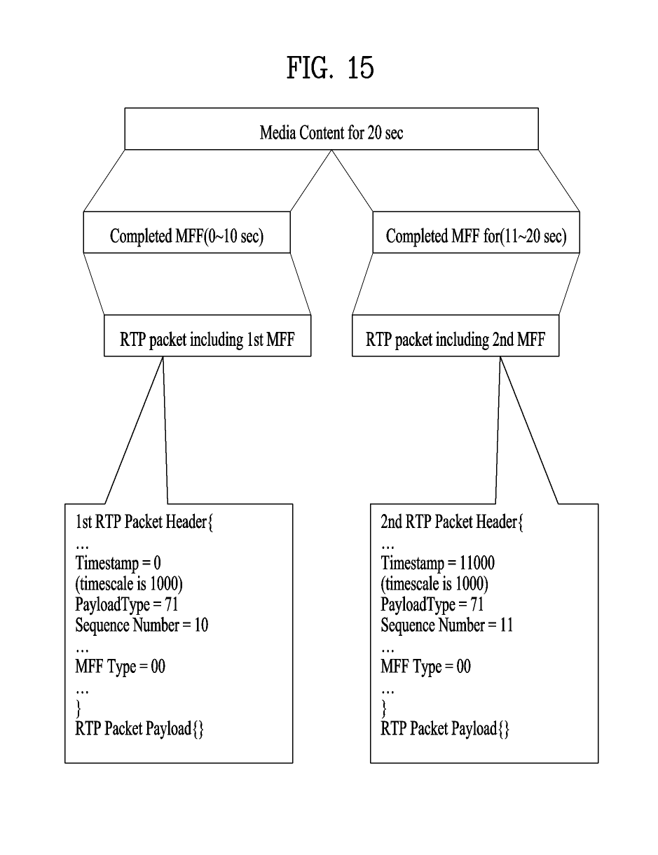

FIG. 15 illustrates a header of a RTP packet including a Completed MFF according to an exemplary embodiment of the present invention.

As shown in this drawing, the 20-seconds-long media content may be divided into two 10-seconds-long Completed MFF files and may then be encoded.

Since a 1st RTP packet includes data starting from 0 second, the Timestamp value may be marked as 0, and the Payload Type is marked as “71”, which indicates that the file corresponds to a MFF file. The Sequence Number may start from an arbitrary number, and, in the case of the exemplary embodiment of FIG. 15, it can be known that the Sequence Number starts from “10”. Since the MFF Type is equal to “00”, it can be known that the Completed MFF file is included in the payload of the corresponding packet.

Since a 2nd RTP packet includes data starting from 11 seconds, the Timestamp value may be marked as 11000, and the Sequence Number value may be marked as “11”.And, the remaining field values may have the same value as the 1st RTP packet.

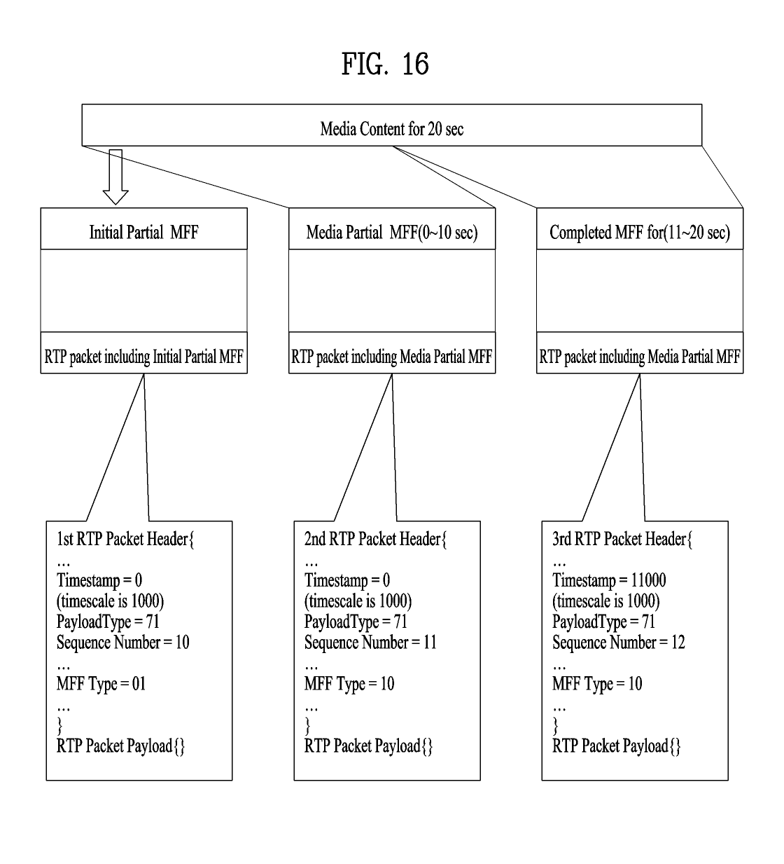

FIG. 16 illustrates a header of a RTP packet in a case when the MFF file is divided into an Initial Partial MFF file and a Media Partial MFF file and then transmitted through the RTP packet according to an exemplary embodiment of the present invention.

As shown in this drawing, the 20-seconds-long media content may be divided into one Initial Partial MFF file and two 10-seconds-long Media Partial MFF files and may then be encoded.

Since a 1st RTP packet includes the Initial Partial MFF file, the analysis of this file should be performed firsthand. Accordingly, this packet should have a Timestamp value that is the same as or faster than that of the Media Partial MFF file, which will be received later on. The Timestamp of the corresponding packet may have a value of 0, and its Payload Type may be marked as “71”, which indicates that the file corresponds to a MFF file. The Sequence Number may start from an arbitrary number, and, in the case of the exemplary embodiment of FIG. 16, it can be known that the Sequence Number starts from “10”. Since the MFF Type is equal to “01”, it can be known that the Initial Partial MFF file is included in the payload of the corresponding packet.

Since a 2nd RTP packet includes a Media Partial MFF file starting from 0 second, the Timestamp value may be marked as 0, and the Payload Type is marked as “71”, which indicates that the file corresponds to a MFF file. The Sequence Number is marked as “11”, and since the MFF Type is marked as “10”, it can be known that the Media Partial MFF file is included the payload of the corresponding packet.

Since a 3rd RTP packet includes a Media Partial MFF file starting from 11 seconds, the Timestamp value may be marked as 11000, and the Payload Type is marked as “71”, which indicates that the file corresponds to a MFF file. The Sequence Number is marked as “12”, and since the MFF Type is marked as “10”, it can be known that the Media Partial MFF file is included the payload of the corresponding packet.

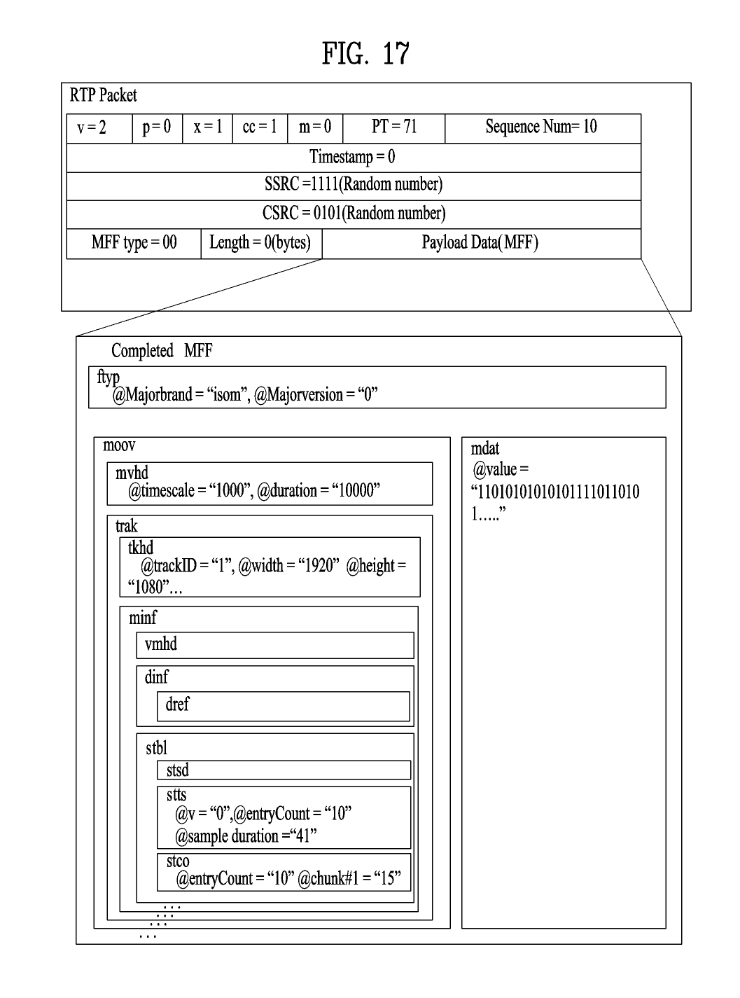

FIG. 17 illustrates structures of a RTP packet and a Completed MFF in a case when the Completed MFF is included in a payload of the RTP packet and then transmitted according to an exemplary embodiment of the present invention.

If the receiving apparatus according to the exemplary embodiment of the present invention receives a packet, as shown in this drawing, the receiving apparatus analyzes the header of the RTP packet and determines information on the packet sequence, data type, and start time point of play (or play start time point), and so on, and, then, the receiving apparatus may analyze the MFF within the Payload.

As shown in this drawing, the MFF may be configured of a data structure having a hierarchical format. In the corresponding MFF, the highest layer information may be configured by being divided into a moov box and a mdat box.

Metadata being associated with file play (or playback) may be included in the moov box, and media data that should be processed with decoding may be included in the mdat box by being aligned in a bit sequence.

The receiver may know a time standard that is used for play (or playback), i.e., how many tics occur per second, through a @timescale value, which is included in the mvhd box within the moov box, and, then, the receiver may know a total length of the corresponding media content and other information through a @duration value, which is included in the mvhd box.

Additionally, the receiver analyzes the tkhd box, which corresponds to a lower layer of the trak box within the moov box, thereby being capable of knowing diverse information, such as @track ID, @width, @height, and so on, and the receiver may know that the corresponding track corresponds to information on a video based upon the presence of the vmhd box located below the minf box, which is another lower layer of the trak box. Additionally, the receiver may know information, such as a number of the total samples (video frames) included in the corresponding MFF, duration value for each sample, and so on, through a value of stts located below the stbl box, which corresponds to a lower layer of the minf box. Furthermore, the boundaries for each sample within the mdat box, wherein the actual media information is aligned in a bit sequence, may be known through the information included in the stco box.

The description provided above on the drawing showing the structure of the Media File Format (MFF) will be substituted for the description of each field configuring the Completed MFF according to the exemplary embodiment of the present invention.

The description provided above on the drawing showing the header structure of the RTP (Real time Transport Protocol) packet will be substituted for the description of each field included in the header of the RTP packet according to the exemplary embodiment of the present invention.

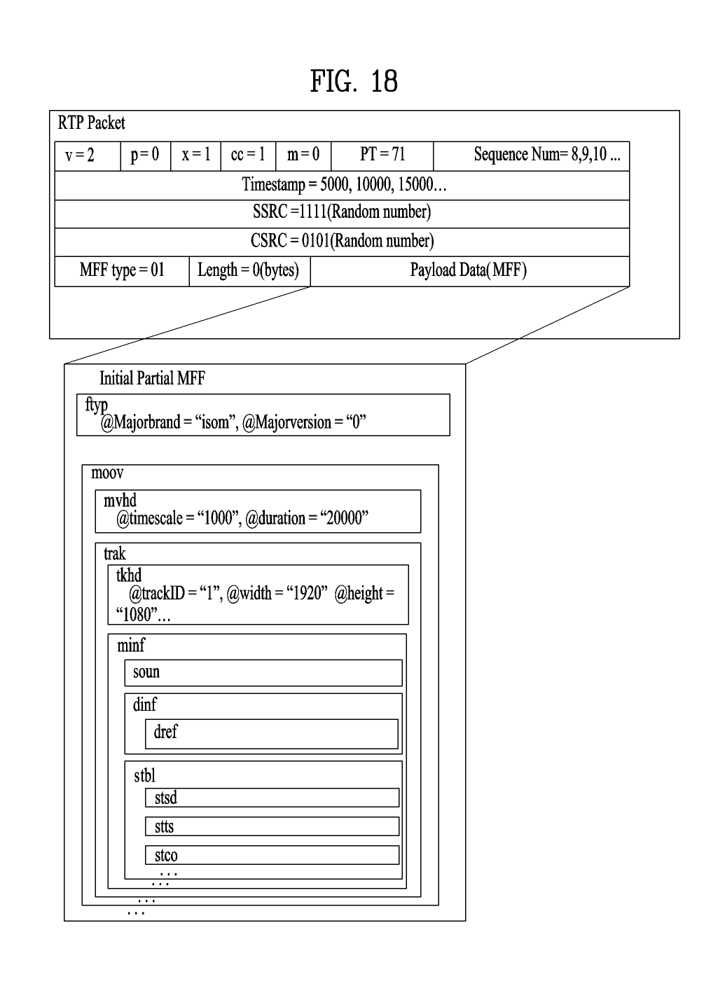

FIG. 18 illustrates structures of a RTP packet and an Initial Partial MFF in a case when the Initial Partial MFF is included in a payload of the RTP packet and then transmitted according to an exemplary embodiment of the present invention.

If the receiving apparatus according to the exemplary embodiment of the present invention receives a packet, as shown in this drawing, the receiving apparatus analyzes the header of the RTP packet and determines information on the packet sequence, data type, and start time point of play (or play start time point), and so on, and, then, the receiving apparatus may analyze the MFF within the Payload.

As shown in this drawing, the MFF may be configured of a data structure having a hierarchical format. In the corresponding MFF, a moov box including metadata associated with file play (or file playback) may exist as the highest layer information.

The receiver may know a time standard that is used for play (or playback), i.e., how many tics occur per second, through a @timescale value, which is included in the mvhd box within the moov box, and, then, the receiver may know a total length of the corresponding media content and other information through a @duration value, which is included in the mvhd box.

Additionally, the receiver analyzes the tkhd box, which corresponds to a lower layer of the trak box within the moov box, thereby being capable of knowing diverse information, such as @track ID, @width, @height, and so on, and the receiver may know information, such as a number of the total samples (video frames) included in the corresponding MFF, duration value for each sample, and so on, through a value of stts located below the stbl box included in the minf box, which corresponds to another lower layer of the trak box. Furthermore, the boundaries for each sample within the mdat box, wherein the actual media information is aligned in a bit sequence, may be known through the information included in the stco box. The mdat box may be included in a Media Partial MFF file, which is received in succession to the packet including the Initial Partial MFF file.

The receiving apparatus according to the exemplary embodiment of the present invention may know the information on the entire content that is being received by using the information included in each box of the Initial Partial MFF.

The description provided above on the drawing showing the structure of the Media File Format (MFF) will be substituted for the description of each field configuring the Initial Partial MFF according to the exemplary embodiment of the present invention.

The description provided above on the drawing showing the header structure of the RTP (Real time Transport Protocol) packet will be substituted for the description of each field included in the header of the RTP packet according to the exemplary embodiment of the present invention.

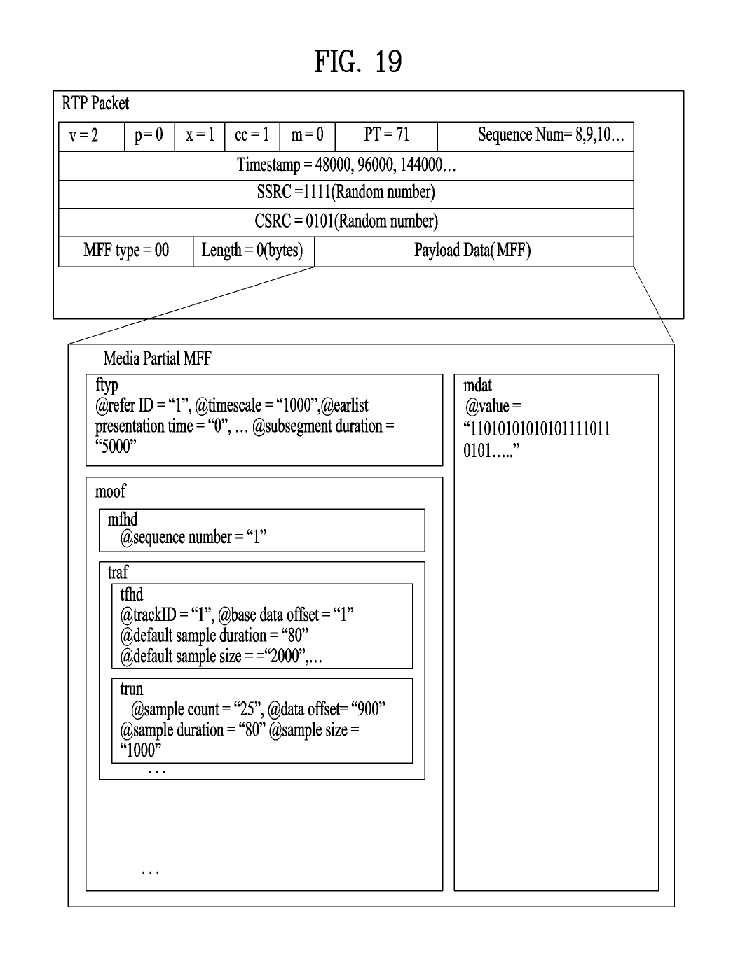

FIG. 19 illustrates structures of a RTP packet and a Media Partial MFF in a case when the Media Partial MFF is included in a payload of the RTP packet and then transmitted according to an exemplary embodiment of the present invention.

If the receiving apparatus according to the exemplary embodiment of the present invention receives a packet, as shown in this drawing, the receiving apparatus analyzes the header of the RTP packet and determines information on the packet sequence, data type, and start time point of play (or play start time point), and so on, and, then, the receiving apparatus may analyze the MFF within the Payload.

As shown in this drawing, the MFF may be configured of a data structure having a hierarchical format. In the corresponding MFF, the highest layer information may be configured by being divided into a sidx box, a moof box, and a mdat box.

Diverse information, such as track information, a divided sequence number, a total length of the divided media, and so on, may be included in the sidx box.

The receiver may know an order position of data within the divided media to which the corresponding Media Partial MFF file corresponds.

Furthermore, the receiver may know information on boundaries of the samples of the mdat box, number of play start time point samples, and so on, through a trun box.

After going through the above-described data processing procedure, the receiving apparatus according to the exemplary embodiment of the present invention may know the play information and play files respective to the divided media of the Media Partial MFF.

The description provided above on the drawing showing the structure of the Media

File Format (MFF) will be substituted for the description of each field configuring the Media Partial MFF according to the exemplary embodiment of the present invention.

The description provided above on the drawing showing the header structure of the RTP (Real time Transport Protocol) packet will be substituted for the description of each field included in the header of the RTP packet according to the exemplary embodiment of the present invention.

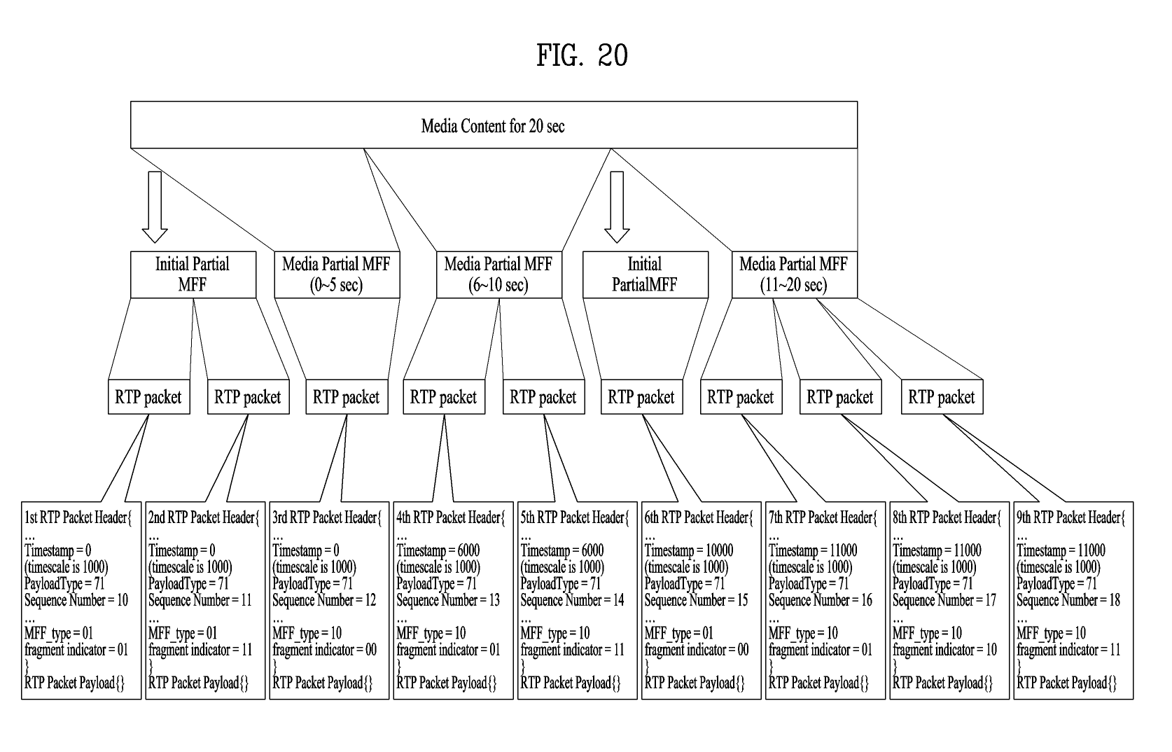

FIG. 20 illustrates a header of a RTP packet in a case when the MFF file is divided in accordance with data types and data sizes and transmitted through the RTP packet according to an exemplary embodiment of the present invention.

As shown in this drawing, the 20-seconds-long media content is first divided into an Initial Partial MFF, Media Partial MFFs having the lengths of 5 seconds, 5 seconds, and 10 seconds, respectively, in accordance with the data type, and, then, the content is divided into a plurality of MFFs in accordance with the data size, and, then, the divided content may be packetized to a RTP packet.

As in a broadcasting system, since a receiving end cannot predict when data are to be received, the transmitting end may periodically transmit the Initial Partial MFF.

In case a first Initial Partial MFF is divided into 2 data in accordance with the data size and then transmitted, the Timestamp of the 1st RTP packet may be equal to 0, the Payload value may be equal to “71”, and the Sequence Number value may start with a random number “10”. Since the 1st RTP packet corresponds to a packet including a first divided data of the Initial Partial MFF file, the value of the Fragment Indicator may be given a value of “01”, and the MFF Type value may be given a value of “01”. A 2nd RTP packet may be given the same Timestamp and Payload Type values as the 1st RTP packet, and the Sequence Number may be given a value of “11”. Since the 2nd RTP packet corresponds to a packet including a last divided data of the Initial Partial MFF file, the value of the Fragment Indicator may be given a value of “11”, and the MFF Type value may be given a value of “01”.

In case a second Media Partial MFF is included in a 3rd RTP packet and then transmitted, since the 3rd RTP packet includes a first start play time point of the media, the Timestamp may be given a value of “0”, the Payload Type may be given a value of “71”, and the Sequence Number may be given a value of “12”. And, since the 3rd RTP packet corresponds to a packet included an undivided Media Partial MFF file, the value of the Fragment Indicator may be given a value of “00”, and the MFF Type value may be given a value of “10”.

In case a third Media Partial MFF is divided into 2 RTP packets and then transmitted, the Timestamp of a 4th RTP packet may be marked as “6000”, which indicates that the corresponding content starts from the 6^{th} second, and the Sequence Number may be given a value of “13”. Since the 4th RTP packet corresponds to a packet including a first divided data of the Media Partial MFF file, the value of the Fragment Indicator may be given a value of “01”, and the MFF Type value may be given a value of “10”. A 5th RTP packet may be given the same Timestamp and Payload Type values as the 4th RTP packet, and the Sequence Number may be given a value of “14”. Since the 5th RTP packet corresponds to a packet including a last divided data of the Media Partial MFF file, the value of the Fragment Indicator may be given a value of “11”, and the MFF Type value may be given a value of “10”.

In case a fourth Initial Partial MFF is included in a 6th RTP and then transmitted, the 6th RTP packet may be given the same Payload Type, Fragment Indicator, and MFF Type values as the 1st RTP packet, and the Sequence Number may be given a value of “15”, and the Timestamp value may be given a value of “10000”, which corresponds to a value faster than a Media Partial MFF that is to be transmitted later on.

In case a fifth Media Partial MFF is divided into 3 RTP packets and then transmitted, the Payload Type of a 7th RTP packet may be given a value of “71”, the Sequence Number may be given a value of “16”, and the Timestamp value may be marked as “11000”, which indicates that the corresponding media has time information respective to 11 seconds. Since the 7th RTP packet corresponds to a packet including a first divided data of the Media Partial MFF file, the value of the Fragment Indicator may be given a value of “01”, and the MFF Type value may be given a value of “10”. A 8th RTP packet may be given the same Timestamp and Payload Type values as the 7th RTP packet, and the Sequence Number may be given a value of “17”. Since the 8th RTP packet corresponds to a packet including a middle divided data (or mid-portion divided data) of the Media Partial MFF file, the value of the Fragment Indicator may be given a value of “10”, and the MFF Type value may be given a value of “10”. The Timestamp and Payload Type values of a 9th RTP packet may be respectively given the same values as the 8th RTP packet, and the Sequence Number may be given a value of “18”. Since the 9th RTP packet corresponds to a packet including a last divided data of the Media Partial MFF file, the Fragment Indicator may be given a value of “11”, and the MFF Type value may be given a value of “10”.

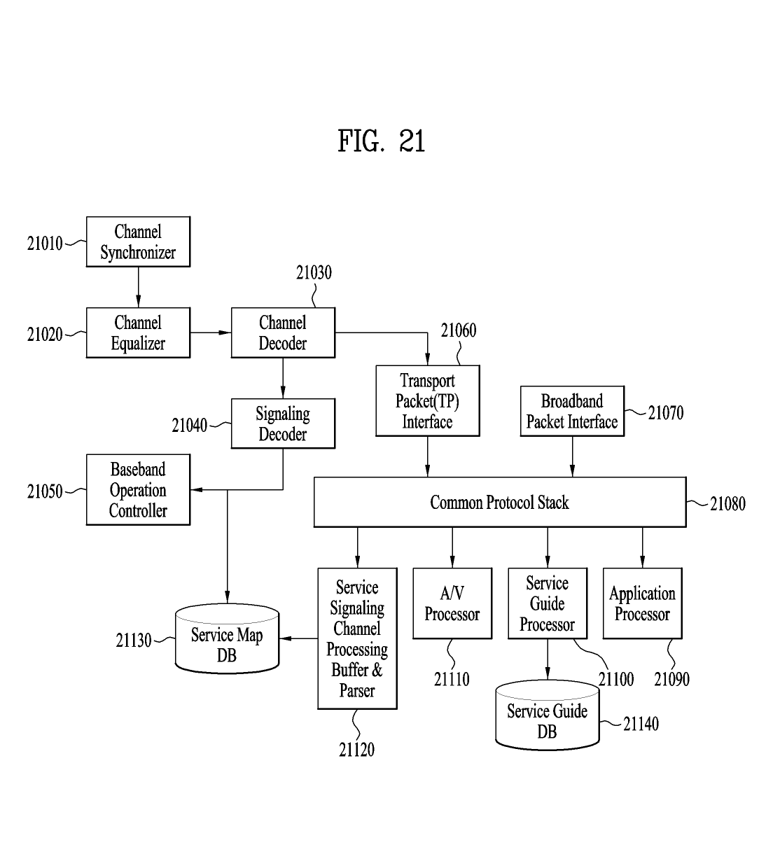

FIG. 21 illustrates an operation flow of an apparatus for receiving a hybrid broadcasting service, which is based on an association between a groundwave (or terrestrial) broadcasting network and an internet protocol network, according to an exemplary embodiment of the present invention.

The apparatus for receiving a hybrid broadcast service according to the exemplary embodiment of the present invention includes a Channel Synchronizer (21020), a Channel Equalizer (21020), a Channel Decoder (21030), a Signaling Decoder (21040), a Baseband Operation Controller (21050), a Transport Packet Interface (21060), a Broadband Packet Interface (21070), a Common Protocol Stack (21080), an Application Processor (21090), a Service Guide Processor (21100), and Audio/Video Processor (A/V Processor; 21110), a Service Signaling Channel Processing Buffer and Parser (21120), a Service Map Database (Service Map DB; 21130), and/or a Service Guide Database (Service Guide DB; 21140).

The Channel Synchronizer (21020) may perform a function of synchronizing a symbol frequency and timing so as to allow adequate decoding to be performed in a baseband.

In case a received signal is distorted due to a Multipath, Doppler effect, and so on, the Channel Equalizer (21020) may perform a function for compensating for such distortion.

The Channel Decoder (21030) may perform a function of recovering the received signal to data having significance. Additionally, this may perform FEC (Forward Error Correction).

The Signaling Decoder (21040) may perform a function of extracting signaling data being delivered from a channel and decoding the extracted data The signaling data being transmitted through the groundwave (or terrestrial) broadcasting network according to the exemplary embodiment of the present invention may be extracted and decoded by the Signaling Decoder (21040), and the signaling data may also be extracted and decoded by the Service Signaling Channel Processing Buffer and Parser (21120), which will be described later on.

The Baseband Operation Controller (21050) may perform a function of controlling diverse processing procedures associated with the baseband.

The Transport Packet Interface (21060) may perform a function of extracting a Transport Packet from a broadcast stream, which is received from the Channel Decoder (21030). Additionally, this may also perform a function of combining signaling or IP datagram from the extracted transport packet.

The Broadband Packet Interface (21070) may perform a function of extracting a Packet, which is acquired through an Internet Protocol network and may also perform a function of combining signaling or A/V data from the corresponding packet.

The Common Protocol Stack (21080) may correspond to the protocol stack shown in FIG. 1. The data that are grouped in packet units by the Common Protocol Stack (21080) may be distinguished (or classified) as signaling, audio data, video data, service guide data, and so on, by passing through each layer of the protocol.

The Application Processor (21090) may perform a function of extracting information associated with an application from the received signal and processing the extracted information.

The Service Guide Processor (21100) may extract Announcement information from the received signal and may manage the Service Guide Database (21140) and may also perform a function of providing a service guide.

The A/V Processor (21110) may perform a function of decoding the received audio and video data and performing Presentation (or play).

The Service Signaling Channel Processing Buffer and Parser (21120) may perform a function of extracting signaling information associated with scanning and acquisition, and so on, of a service or content from the IP datagram, and so on, and parsing the extracted signaling information. Additionally, the Service Signaling Channel Processing Buffer and Parser (21120) may include the Signaling Decoder (21040). Moreover, the Service Signaling Channel Processing Buffer and Parser (21120) including the Signaling Decoder (21040) may be referred to as a signaling information processing unit, and each of the Signaling Decoder (21040 and the Service Signaling Channel Processing Buffer and Parser (21120) may also be referred to as the Signaling information processing unit. As signaling information associated with the acquisition of a broadcast service, component identification information, transmission network type information, data path information, version information of a ISO base media file format standard, and/or profile information of an ISO base media file format stream, which are included in a service information table according to the exemplary embodiment of the present invention, may be extracted and parsed by the signaling information processing unit.

The Service Map DB (21130) may perform a function of storing signaling information, which is decoded by the Signaling Decoder (21040), the Service Signaling Channel Processing Buffer and Parser (21120), or the signaling information processing unit.

The Service Guide DB (21140) may perform a function of storing a service guide, which is extracted and processed by the Service Guide Processor (21100).

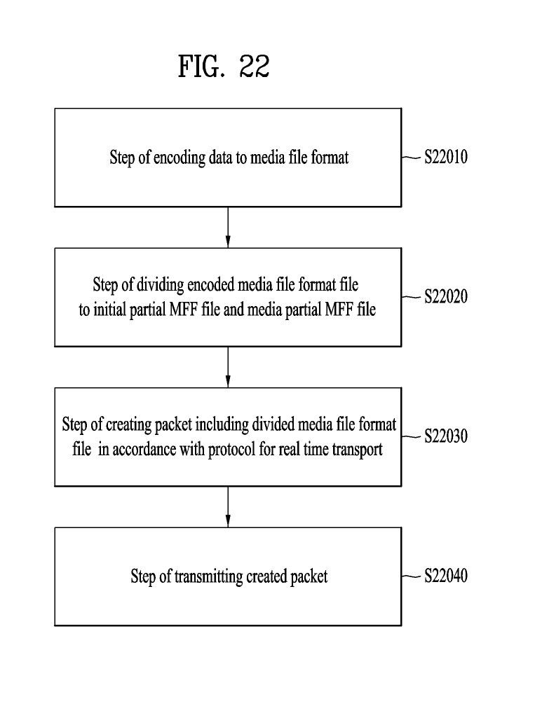

FIG. 22 illustrates a flow of a method for transmitting a media broadcasting signal according to an exemplary embodiment of the present invention.

According to the exemplary embodiment of the present invention, a media broadcasting signal may be transmitted by undergoing the following procedure. Firstly, data are encoded in a Media File Format (MFF) (S22010). Herein, the data may include media data, such as audio data or video data And, the description of the Media File Format has been described in the description of the terms and abbreviations provided above. As its following process step, the encoded Media File Format file may be divided into an Initial Partial MFF file and a Media Partial MFF file in accordance with the data type (S22020). At this point, the Initial Partial MFF file may include metadata having play information and initial play information of the entire media file, and the Media Partial MFF file may include media data and metadata having partial play information associated with the media data The description of this has already been provided above in the description of FIGS. 6 to 11. As its following process step, a packet including the divided Media File Format file is created in accordance with the protocol for real time transport (S22030). Herein, the transport protocol may include a real time transport protocol, a non real time transport protocol, and so on. In this step, the media file that is encoded in a Media File Format is packetized in accordance with the transport protocol. At this point, a header of the created packet may include Media File Format (MFF) type information, which identifies whether the divided Media File Format file included in the Payload corresponds to an Initial Partial MFF file or a Media Partial MFF file. The description of this has already been provided above in the description of FIGS. 6 to 11 and FIGS. 15 to 20. As its following process step, the created packet is transmitted (S22040). Herein, the data that are packetized by the transport protocol may be transmitted through at least any one of a groundwave (or terrestrial) broadcasting network, a cable network, and an Internet protocol network.

According to another exemplary embodiment of the present invention, a header of the packet, which is created in the step of creating the packet (S22030), may include Payload Type information indicating the format of the data included in the Payload, and the details on the Payload Type information have been described above in the description of FIG. 4. Additionally, diverse types of file formats are defined in the Payload Type information may identify that the data included in the Payload correspond to a Media File Format (MFF). The details of this haven been described above in the description of FIG. 5.

According to yet another exemplary embodiment of the present invention, a header of the packet, which is created in the step of creating the packet (S22030), may include Timestamp information indicating a start time point at which the Media File Format (MFF) file included in the Payload is played. And, the packet including the Initial Partial MFF file may have Timestamp information that is the same as or faster than the packet including the Media Partial MFF file. The description of this has been provided above in the description of FIGS. 6 to 16.

According to yet another exemplary embodiment of the present invention, the packet including the Initial Partial MFF file may be continuously transmitted on a periodic basis. The description of this has been provided above in the description of FIGS. 6 to 9.

According to yet another exemplary embodiment of the present invention, instead of the step of dividing the encoded Media File Format file in accordance with the data type, a step of dividing the file in accordance with the data size may be included. As described in this exemplary embodiment, in case of dividing the Media File Format file in accordance with the data size and then transmitting the file, Fragment Indicator information, which distinguishes the divided Media File Format file included in the Payload of the corresponding packet in accordance with a data sequence (or order), may be included in the header of the packet transmitting the divided Media File Format file. The details of this are described above in FIGS. 12 to 14 and FIG. 20.

According to yet another exemplary embodiment of the present invention, the encoded Media File Format file may be divided into any one of a first data, a middle data (or mid-portion data), and a last data, which configure the entire media file, in accordance with the data sequence (or order). And, in case the Media File Format file is divided in accordance with the data size and then transmitted, a header of the packet transmitting the divided Media File Format file may include Timestamp information indicating a play start time point of the Media File Format file included in the Payload. And, each packet transmitting a Media File Format file, which is distinguished in accordance with the data sequence, may have the same Timestamp information. The description of this has been provided above in the description of FIGS. 12 to 14.

According to yet another exemplary embodiment of the present invention, the Media File Format file, which is divided in accordance with the data type, may be divided once again in accordance with the data size and may then be transmitted. The description of this has been provided above in the description of FIG. 20.

According to yet another exemplary embodiment of the present invention, a protocol for real time transport may be used as the protocol for transmitting the Media File Format file, and, among the protocols for real time transport, the RTP (Real time Transport Protocol) may be used.

According to yet another exemplary embodiment of the present invention, the Media File Format file that is being transmitted may include an ISOBMFF (ISO Base Media File Format).

Although the drawings have been distinguished and divided in order to facilitate the description of the present invention, the present invention may provide a design for configuring a new embodiment by combining some of the previously described embodiments of the present invention. Moreover, whenever required by anyone skilled in the art, the scope of the present invention includes designing a recording medium readable by a computer, the computer having a program for executing the above-described embodiments of the present invention recorded therein.

As described above, the device and method according to the present invention may not be limited only to the above-described configuration and methods according to the exemplary embodiments of the present invention, and, therefore, variations of the exemplary embodiments of the present invention may be configured by selectively combining each exemplary embodiment of the present invention fully or in part.

Meanwhile, the image processing method according to the present invention may be realized as a code that can be read by a processor, which is provided in a network device, in a recording medium that can be read by a processor. The recording medium that can be read by the processor includes all types of recording devices storing data that can be read by the processor. Examples of the recording media that can be read by a processor may include ROMs, RAMs, CD-ROMs, magnetic tapes, floppy disks, optical data storing devices, and so on. Also, an exemplary recording medium being realized in the form of a carrier wave, such as a transmission via Internet, may also be included. Also, the recording medium that can be read by a processor may be scattered within a computer system, which is connected through a network. And, a code that can be read by the processor may be stored and executed by using a dispersion (or scattering) method.

It will be apparent to those skilled in the art that various modifications and variations can be made in this specification without departing from the spirit or scope of this specification. Thus, it is intended that this specification covers the modifications and variations of this invention provided they come within the scope of the appended claims and their equivalents. It is also apparent that such variations of this specification are not to be understood individually or separately from the technical scope or spirit of this specification.

Also, a device invention and a method invention are both described in this specification. Therefore, whenever required, the description of both inventions may be supplementarily applied.

### MODE FOR CARRYING OUT THE INVENTION

As described above, the mode for carrying out the invention has been described above in the best mode for carrying out the invention.

### INDUSTRIAL APPLICABILITY

The present invention is applicable throughout the entire broadcasting industry.

What is claimed is:

1. An apparatus for receiving a media broadcasting signal, comprising:
a receiving unit for receiving a packet by a protocol for real time transport, wherein a payload of the packet includes a Media File Format (MFF) file divided according to types of data, and the divided Media File Format (MFF) file corresponds to any one of an initial partial MFF file comprising metadata having entire play information and initial play information, and a media partial MFF file including metadata having media data and partial play information associated with the media data,
wherein a header of the packet includes Media File Format (MFF) type information identifying whether the divided Media File Format (MFF) file included in the payload corresponds to the initial partial MFF file or the media partial MFF file;
a parsing unit for distinguishing the metadata and the media data from each other by analyzing the Media File Format (MFF) file and extracting information required for the play;
a decoder for decoding the Media File Format (MFF) file outputted from the parsing unit; and
a play unit for playing a decoded Media File Format (MFF) file by using the information extracted from the parsing unit.

2. The apparatus of claim 1, further comprising:
a buffer for storing data included in a payload of the received packet; and
a control unit for performing control operations so as to store the initial partial MFF file in the buffer, in case of receiving a packet including an initial partial MFF file, and for performing control operations so as to verify whether or not the initial partial MFF file is stored in the buffer, in case of receiving a packet including a media partial MFF file, and, if the file is stored in the buffer, to output the media partial MFF file to the parsing unit along with the initial partial MFF file stored in the buffer, and, if the file is not stored in the buffer, to allow the receiving unit to receive a new packet.

3. The apparatus of claim 1, wherein a header of the packet includes Payload Type information indicating a format of the data included in the payload, and wherein the Payload Type information identifies whether or not the data included in the payload correspond to a Media File Format (MFF).

4. The apparatus of claim 1, wherein a header of the packet further includes Timestamp information indicating a start point at which the Media File Format (MFF) file included in the payload is played,
wherein the packet including the initial partial MFF file has Timestamp information the same as or faster than that of the packet including the media partial MFF file.

5. The apparatus of claim 1, wherein the packet including the initial partial MFF file is continuously received on a periodic basis.

6. The apparatus of claim 1, wherein the protocol for real time transport includes a RTP (Real time Transport Protocol).

7. The apparatus of claim 1, wherein the Media File Format (MFF) includes an ISOBMFF (ISO Base Media File Format).

8. A method for transmitting a media broadcasting signal, comprising:
a step of encoding media data including audio data and/or video data to a Media File Format (MFF);
a step of dividing the encoded Media File Format (MFF) file into an initial partial MFF file comprising metadata having entire play information and initial play information, and a media partial MFF file including metadata having media data and partial play information associated with the media data in accordance with the type of data;
a step of creating a packet including the divided Media File Format (MFF) file in accordance with a protocol for real time transport,
wherein a header of the created packet includes Media File Format (MFF) type information identifying whether the divided Media File Format (MFF) file included in the payload corresponds to the initial partial MFF file or the media partial MFF file; and
a step of transmitting the created packet.

9. The method of claim 8, wherein a header of the created packet includes Payload Type information indicating a format of the data included in the payload, and wherein the Payload Type information identifies whether or not the data included in the payload correspond to a Media File Format (MFF).

10. The method of claim 8, wherein a header of the created packet further includes Timestamp information indicating a start point at which the Media File Format (MFF) file included in the payload is played,
wherein the packet including the initial partial MFF file has Timestamp information the same as or faster than that of the packet including the media partial MFF file.

11. The method of claim 8, wherein the packet including the initial partial MFF file is continuously received on a periodic basis.

12. The method of claim 8, wherein the protocol for real time transport includes a RTP (Real time Transport Protocol).

13. The method of claim 8, wherein the Media File Format (MFF) includes an ISOBMFF (ISO Base Media File Format).
